(19) United States
(12) Patent Application Publication
(10) Pub. No.: US 2017/0112125 A1
(43) Pub. Date: Apr. 27, 2017

(54) PROCESSES FOR PREPARING IMPROVED COMPOSITIONS

(71) Applicants: Steven Paul Rannard, Liverpool (GB); David Duncalf, Liverpool (GB); Alison Jayne Foster, Liverpool (GB); James Long, Liverpool (GB); Dong Wang, Liverpool (GB)

(72) Inventors: Steven Paul Rannard, Liverpool (GB); David Duncalf, Liverpool (GB); Alison Jayne Foster, Liverpool (GB); James Long, Liverpool (GB); Dong Wang, Liverpool (GB)

(21) Appl. No.: 15/282,938

(22) Filed: Sep. 30, 2016

Related U.S. Application Data
(62) Division of application No. 13/877,864, filed on Apr. 4, 2013, now abandoned.

(30) Foreign Application Priority Data
Oct. 5, 2010 (GB) 1016765.8
Oct. 5, 2010 (GB) 1016776.5

(51) Int. Cl. A01N 25/04; A01N 25/22; A01N 43/90; A01N 43/653; A23K 20/10; A01N 47/38; A01N 43/40; A01N 43/54; A01N 25/30; A23L 33/10; A01N 53/00; A01N 47/02

(52) U.S. Cl. CPC A01N 25/04; A01N 53/00; A01N 25/22; A01N 43/90; A01N 43/653; A01N 47/02; A01N 47/38; A01N 43/40; A01N 43/54; A01N 25/30; A23L 33/10; A23K 20/10; A23V 2002/00

(57) ABSTRACT

The invention provides a method for preparing an improved composition comprising at least one active agent and at least one solid carrier material, wherein the active agent is dispersed through the carrier material in nano-disperse form, which method comprises the steps of: (a) forming a liquid mixture comprising the active agent, the carrier material, a stabilizing agent, a first solvent for the active agent and the stabilizing agent and, a second solvent for the carrier material, and (b) drying the liquid mixture to remove the first and second solvents to obtain a substantially solvent-free nano-dispersion of the active agent with the stabilising agent in the carrier material, wherein the stabilizing agent is capable of stabilizing the active agent in the liquid mixture during drying and in a resultant liquid nano-dispersion of the improved composition.

The present invention relates to processes for preparing improved compositions, and especially to processes for preparing improved compositions comprising a nano-dispersion of at least one active agent in at least one solid carrier material. The present invention also relates to improved compositions obtained by the processes of the present invention, and further to improved liquid nano-dispersions obtained from the improved compositions of the invention.

Many solid materials with desirable functional properties (herein referred to as “active agents”) are usually administered in the form of a liquid system. However these active agents are often either (a) water-insoluble or have a very low water-solubility or (b) water-soluble but oil-insoluble or have a very low solubility in oil, which can be problematic depending on the nature of the liquid system sought to be used for its administration. In the case of water-insoluble active agents, e.g. pharmaceuticals, such poor solubility can make their administration difficult and their bioavailability low. Similar problems arise with biocides such as insecticides, herbicides and fungicides, and indeed many other active agents to be described in more detail hereinafter.

It is known that the rate of dissolution of active agents can be increased by increasing the surface area of the solid, i.e. by decreasing the particle size preferably to the micron or sub-micron range at least. Consequently, significant efforts have been made to control the size range of active agents in liquid delivery systems. One known approach to this problem is to grind and/or mill solid bulk active agent materials to form fine particles, however there are practical limits to milling and grinding and it is difficult to obtain materials with a particle size below 1 micron. Particle sizes below 0.5 micron may be possible, but are not simple to obtain without the use of specialist milling equipment. Furthermore, particle size and distribution depend on a variety of parameters like the type of mill or the crushing parts used. A further problem arises in the removal of the crushing parts after milling; if smaller grinding fractions are needed, often the smaller crushing parts and grinding dust are left in the ground product yielding a heterogeneous system. Because of the larger particle size of some milled materials it is more difficult to find additives to stabilize a dispersion of these particles against, for example, agglomeration, flocculation and sedimentation.

Alternative approaches to the formation of organic particles of decreased size (i.e. micron or sub-micron) are summarized in the paper entitled “Aqueous Nanoparticles in the Aqueous Phase—Theory, Experiment and Use” by D. Horn and J. Rieger, Agnew. Chem. Int. Ed., 2001, 40, 4330-4361. For example, it is possible to start from a molecular solution and to form the desired active agent particles by precipitation. Generally, the precipitation process is induced in a nucleation stage by changing the compatibility of the active agent solute with the surrounding solvent, for example, by changing or mixing of solvents, changes in pH value, temperature, pressure and/or concentration. However such a process faces a number of problems, including Ostwald ripening (a thermodynamically-driven, spontaneous process during which large precipitated particles grow at the expense of smaller precipitated particles, which correspondingly shrink in size), particle agglomeration resulting in sedimentation and/or flotation, etc.

A yet further alternative approach is described in our own international patent applications published as WO2006/079409 and WO2008/006712, each of which describe how a water-insoluble material, which will form a nano-dispersion in water, can be prepared, preferably by a spray-drying process. In WO2006/079409, the water-insoluble materials are dissolved in the solvent-phase (i.e. the “oil” phase) of an emulsion, whilst a water-soluble carrier material is dissolved in the aqueous phase of the emulsion. In WO2008/006712, the water-insoluble materials are dissolved in a single phase mixed solvent system and co-exist in the same phase as a water-soluble carrier material. In both cases the liquid (i.e. the emulsion or the single phase mix of solvents) is dried above ambient temperature, such as by spray-drying, to produce powder particles of the carrier material with the water-insoluble materials dispersed therein in nano-disperse form. When these powder particles are subsequently added to water, the water-soluble carrier material dissolves to form a nano-dispersion of the water-insoluble material, with said nano-particles having a z-average particle size of typically below 800 nm in the water. The water-insoluble material thus behaves as though it were in solution.

It has however been observed that when a number of active agents, e.g. strobilurin fungicides, are used in the proprietary methods herein described, the liquid system may undergo physical destabilization (prior to any drying step) in the same way as has been observed with other small-particle formation processes, namely in the form of particle growth leading to precipitation of the active agent material out of the liquid solution in question, whether emulsion, single-phase solution or subsequently formed liquid dispersion. Particle growth is undesirable for a number of reasons: firstly, it is in contradiction to the aim of achieving small particle sizes (micron and sub-micron); secondly, when solid particulate matter of active agent precipitates out of its liquid medium, the shelf life of the liquid system may be reduced; thirdly, the functional activity of the active agent may reduce as the active surface area is reduced; and finally, the particulate active agent material may become visible in the solution as its particulate size grows. It is thought that the main processes behind such particle growth include (1) aggregation/agglomeration of particles as a result of collisions caused by Brownian motion and (2) Ostwald ripening (as described earlier).

It would therefore be desirable to inhibit these particle growth processes for active agents with which they would otherwise be observed so as to preserve the intended particle size and the attendant functional benefits.

### First Aspect

Accordingly, the present invention provides a method for preparing an improved composition comprising at least one active agent and at least one solid carrier material, wherein the active agent is dispersed through the carrier material in nano-disperse form, which method comprises the steps of:
(a) forming a liquid mixture comprising the active agent, the carrier material, a stabilizing agent, a first solvent for the active agent and the stabilizing agent and a second solvent for the carrier material, and
(b) drying the liquid mixture to remove the first and second solvents to obtain a substantially solvent-free nano-dispersion of the active agent with the stabilizing agent in the carrier material,
   wherein the stabilizing agent is capable of stabilizing the active agent in the liquid mixture during drying and in a resultant liquid nano-dispersion of the improved composition.

It has been observed that addition of a stabilizing agent to the liquid mixture comprising the active agent, carrier material and first and second solvents reduces and often inhibits the physical destabilization processes that would otherwise be observed with a number of active agents. It is believed that the stabilizing agent provides steric stabilization to the mixture so as to maintain the nanometre particle size of the active agent in the carrier material. Furthermore it is believed that the stabilizing agent “co-exists” with the nano-particles of active agent within the carrier material so as to thereby effectively create nano-co-particles of active agent/stabilizing agent. Of course, it is not expected that the composition of each nano-co-particle will be identical; the extent of co-existence need only be sufficient so as to inhibit the physical destabilization processes discussed above.

An immediate benefit of the present invention is that it enables control of particle size formation of certain active agents (e.g. azoxystrobin, prochloraz, fipronil, kresoxim-methyl) that would otherwise not be able to be formed into an improved composition, and hence have the benefits described, which will be described in more detail below.

An additional benefit of the present invention is that, upon dissolution of the carrier material in a liquid medium, dispersion of the stabilised active agent can occur extremely rapidly, preferably within five minutes of having been introduced into the liquid medium, further preferably within three minutes and most preferably in under one minute. Furthermore, the presence of the stabilization agent inhibits the physical destabilization processes of agglomeration and/or aggregation that might otherwise be observed.

In one alternative, the method of the present invention may be further defined by:
(a) forming an emulsion comprising:
   (i) a solution of the active agent and the stabilizing agent in the first solvent, and
   (ii) a solution of the carrier material in the second solvent, and
(b) drying the emulsion to remove the first and second solvents to obtain a substantially solvent-free nano-dispersion of the active agent stabilized by the stabilizing agent in the carrier material.

For convenience, this method is referred to herein as the “emulsion” method.

Preferably, the emulsion may be an oil-in-water (O/W) emulsion, wherein:
(i) both the active agent and the stabilizing agent are water-insoluble and the first solvent is a water-immiscible non-aqueous solvent (forming the “internal” or “disperse” phase of the emulsion), and
(ii) the solid carrier material is water-soluble and the second solvent is water (forming the “external” or “continuous” phase of the emulsion).

Preferably, the non-aqueous internal phase comprises from about 10% to about 95% v/v of the emulsion, more preferably from about 20% to about 68% v/v.

Alternatively, the emulsion may be a water-in-oil (W/O) emulsion, wherein:
(i) both the active agent and the stabilizing agent are water-soluble and the first solvent is water (forming the “internal” or “disperse” phase of the emulsion), and
(ii) the solid carrier material is water-insoluble and the second solvent is a water-immiscible non-aqueous solvent (forming the “external” or “continuous” phase of the emulsion).

Preferably, the aqueous internal phase comprises from about 10% to about 95% v/v of the emulsion, more preferably from about 20% to about 68% v/v.

Further preferably, the emulsion may be one in which the internal (or disperse) phase is formed by the active agent and stabilizing agent in a hydrophilic solvent, whilst the external (or continuous) phase is formed by the solid carrier material in a hydrophobic solvent.

The emulsions are typically prepared under conditions which are well known to those skilled in the art, for example, by using a magnetic stirring bar, a homogeniser, or a sonicator. The emulsions need not be particularly stable, provided that they do not undergo extensive phase separation prior to drying.

In a preferred method according to the invention, an emulsion is prepared with an average dispersed-phase droplet size (using the Malvern peak intensity) of between 10 nm and 5000 nm. Sonication is also a particularly preferred way of reducing the droplet size for emulsion systems. We have found that a Heat Systems Sonicator XL operated at level 10 for two minutes is suitable.

In another alternative form, the method of the present invention may be further defined by:
(a) forming a single-phase solution comprising:
   (i) a mixture of the first and second solvents which are miscible with one another,
   (ii) the active agent, which is soluble in the mixture of first and second solvents,
   (iii) the carrier material, which is soluble in the mixture of the first and second solvents, and
   (iv) the stabilizing agent, which is soluble in the mixture of the first and second solvents, to stabilize the active agent in the single-phase solution, and
(b) drying the solution to remove the first and second solvents to obtain a substantially solvent-free nano-dispersion of the active agent stabilized by the stabilizing agent in the carrier material.

For convenience, this method is referred to herein as the “single-phase” method. In some limited circumstances, it is possible that a single solvent may be used for all of the active agent, the stabilizing agent and the carrier material to achieve a single-phase solution to be dried as per part (b) above.

However, more generally, in the single-phase method, the single-phase solution may be an aqueous solution, in which the first and/or second solvents may be aqueous solvents, the carrier material will be water-soluble and both the active agent and the stabilizing agent will be water-insoluble.

Alternatively, the single-phase solution may be a non-aqueous solution, in which the first and/or second solvents may be non-aqueous solvents, the carrier material will be water-insoluble, and both the active agent and the stabilizing agent will be water-soluble.

In the context of the present invention, “water-insoluble” as applied to the active agent, the carrier material and/or the stabilizing agent means that its solubility in water at ambient temperature and pressure is less than 10 g/L, preferably less than 5 g/L, more preferably less than 1 g/L, even more preferably less than 150 mg/L, and especially less than 100 mg/L. This solubility level provides the intended interpretation of what is meant by “water-insoluble” in the present specification.

Similarly, in the context of the present invention, “water-soluble” as applied to the active agent, the carrier material and/or the stabilizing agent means that its solubility in water at ambient temperature and pressure is at least 10 g/L. The term “water-soluble” includes the formation of structured aqueous phases as well as true ionic solution of molecularly mono-disperse species.

For the avoidance of any doubt, in the present application the term “ambient temperature” means 25° C. whilst “ambient pressure” means 1 atmosphere (101.325 kPa) of pressure.

As discussed above, the improved compositions of the present invention are substantially solvent-free. In the context of the present invention, the term “substantially solvent-free” means that the free solvent content of the compositions is less than 15%, preferably below 10%, more preferably below 5% and most preferably below 2%. For the avoidance of doubt, throughout this specification, all percentages are percentages by weight unless otherwise specified.

### Particle Sizing

Throughout the specification, by a “nano-disperse” and like terms we mean a dispersion in which the z-average particle size (diameter), otherwise known as the hydrodynamic diameter, is less than 1000 nm. Preferably, the z-average diameter of the nano-disperse form of the active agent is below 800 nm, even more preferably below 500 nm, especially below 200 nm, and most especially below 100 nm. For example, the z-average diameter of the nano-disperse form of the active agent may be in the range of from 50 to 750 nm, more preferably 75 to 600 nm.

The preferred method of particle sizing for the dispersed products of the present invention employs a Dynamic Light Scattering (DLS) instrument (Nano S, manufactured by Malvern Instruments UK). Specifically, the Malvern Instruments Nano S uses a red (633 nm) 4 mW Helium-Neon laser to illuminate a standard optical quality UV cuvette containing a suspension of the particles to be sized. The particle sizes quoted in this application are those obtained with that apparatus using the standard protocol provided by the instrument manufacturer. The size of the nano-particles in a dry solid material, such as the size of the active agent nano-particles and active agent/stabilizing agent nano-co-particles, are inferred from the measurement of the particle size subsequent to the dry solid material being dispersed in water.

The nano-scale size of the active agent particles, sterically stabilized by the stabilizing agent, means that “water-clear” dispersions may be achieved. A water-clear dispersion is one in which the dispersed active agent particles in an aqueous medium are invisible to the naked eye and the liquid appears clear, whereas precipitation of the active agent out of the liquid medium may otherwise have occurred, as discussed earlier.

### Stabilizing Agents

In the present invention, the stabilizing agent used may be either hydrophobic or hydrophilic depending on the overall characteristics of the liquid mixture in question. If hydrophobic, the stabilizing agent is preferably a polymeric material, but may also be a non-polymeric material. If hydrophilic, the stabilizing agent is preferably polymeric.

A stabilizing polymeric material may have a weight average molecular weight (MW) in the range of from 10-500 kg/mole, preferably in the range of from 30-470 kg/mole and further preferably in the range of from 50-400 kg/mole.

Indeed, a hydrophobic stabilizing polymeric material may be selected from polymethylmethacrylate (PMMA), polymethylmethacrylate-co-methacrylic acid (PMMA-MA), polybutylmethacrylate (PBMA), polystyrene (PS), polyvinylacetate (PVAC), polypropyleneglycol (PPG), poly(styrene-co-methyl methacrylate), poly(vinylpyrrolidone-co-vinyl acetate), poly(vinyl acetate-co-croton-aldehyde, and mixtures thereof.

A hydrophobic stabilizing non-polymeric material may be selected from safflower seed oil, paraffin oil, paraffin wax, beeswax, vitamin E, vitamin E acetate, cholesterol, trimethoxysilane, hexadecyltrimethoxysilane, octadecylamine, stearic acid (and other fatty acids), cetyl alcohol, octadecanol (and other fatty alcohols), Span™ 83 (and other hydrophobic surfactants), and mixtures thereof.

A hydrophilic stabilizing polymeric material may be chosen for the list of water-soluble polymeric materials to be defined hereinafter.

In the cases where the active agent is water-insoluble, the stabilizing agent is preferably hydrophobic, whereas in cases where the active agent is water-soluble, the stabilizing agent is preferably hydrophilic.

### Active Agents

A wide range of useful active agents are suitable for use in the methods of the present invention, either as single compounds or a mixture of materials which may be either similar or dissimilar in activity.

The active agent may be one or more of the following: a pharmaceutical, a nutraceutical, an animal health product, an agrochemical, a biocidal compound, a food additive (including flavourings), a polymer, a protein, a peptide, a cosmetic ingredient, a coating, an ink/dye/colourant, a laundry or household cleaning and care product. Because of the water-insoluble or oil-insoluble nature of the active agents and the tendency for particle destabilization, they are typically difficult to disperse in an aqueous or non-aqueous environment respectively. Use of the stabilized matrices of the present invention facilitates this dispersion and in many cases enables water-insoluble or oil-insoluble active agents to be dispersed more effectively than previously.

Suitable water-insoluble active agents include:
antidandruff agents, for example, zinc pyrithione;
skin lightening agents, for example, 4-ethylresorcinol;
skin conditioning agents, for example, cholesterol;
hair conditioning agents, for example, quaternary ammonium compounds, protein hydrolysates, peptides, ceramides and hydrophobic conditioning oils, such as hydrocarbon oils, including paraffin oils and/or mineral oils, fatty esters such as mono-, di-, and tri-glycerides, silicone oils such as polydimethylsiloxanes (e.g. dimethicone);
dyes, for example, azo-dyes, diazo-dyes, phthalocyanine dyes, anthroquinone dyes;
fluorescing agents, for example, 2,5-bis(2-benzoxazolyl) thiophene (Tinopal SOP) for use on fabrics (such as cotton, nylon, polycotton or polyester) in laundry products;
UV protecting agents, such as sunscreens, for example, octyl methoxycinnamate (Parsol MCX), butyl methoxydibenzoylmethane (Parsol 1789), benzophenone-3 (Uvinui M-40), and feruiic acid;
thickening agents, for example, hydrophobically modified cellulose ethers such as modified hydroxyethylcelluloses;
bleach or bleach precursors, for example, 6-N-phthalimidoperoxyhexanoic acid (PAP) or photobleaching compounds;
perfumes or flavourings or precursors thereto and antioxidants, for example, antioxiants based on hydroxytoluene such as Irganox™ or commercially available antioxidants such as the Trollox™ series; and
pharmaceutically and otherwise biologically active compounds, for example, sartans, statins, NSAIDS, antifungals (for example organochlorines including Chlorothalonil and imidazoles such as Ketoconazole and Propiconazole) herbicides (for example phenol-ureas including Isoproturon), acaricides, algicides, insecticides, fungicides, molluscicides and nematacides, animal pesticides (for example rodenticides), plant growth regulators and fertilizers, antiparasitics, vasodilators, CNS actives, antihypertensives, hormones, anticancer agents, sterols, analgesics, anaesthetics, antivirals, antiretrovirals, antihistamines, antibacterials (for example chlorophenols including Triclosan), and antibiotics, vitamins (such as vitamin E, retinol), vitamin-like substances such as co-enzyme Q (ubiquinone).

Particularly suitable fungicides are strobilurin fungicides, a wide range of which are suitable for use in the method of the present invention, either as single compounds or a mixture of materials. Suitable strobilurin fungicides include:
Methyl (2E)-2-{2-[6-(2-cyanophenoxy)pyrimidin-4-yloxy]phenyl}-3-methoxyacrylate (azoxystrobin);
Methyl (2EZ)-3-(fluoromethoxy)-2-[2-(3,5,6-trichloro-2-yridyloxymethyl)phenyl]acrylate (bifujunzhi);
Methyl (2E)-2-{2-[(3-butyl-4-methyl-2-oxo-2H-chromen-7-yl)oxymethyl]phenyl}-3-methoxyacrylate (coumoxystrobin);
(E)-2-(methoxyimino)-N-methyl-2-[α-(2,5-xylyloxy)-o-tolyl]acetamide (dimoxystrobin);
Methyl 2-{2-[({[3-(4-chlorophenyl)-1-methylprop-2-enylidene]amino}oxy)methyl]phenyl}-3-methoxyacrylate (enestroburin);
(E)-{2-[6-(2-chlorophenoxy)-5-fluoropyrimidin-4-yloxy]phenyl}(5,6-dihydro-1,4,2-dioxazin-3-yl)methanone O-methyloxime (fluoxastrobin);
Methyl (2E)-2-{2-[(3,4-dimethyl-2-oxo-2H-chromen-7-yl)oxymethyl]phenyl}-3-methoxyacrylate (jiaxiangjunzhi);
Methyl (E)-methoxyimino[α-(o-tolyloxy)-o-tolyl]acetate (kresoxim-methyl);
(E)-2-(methoxyimino)-N-methyl-2-(2-phenoxyphenyl)acetamide (metominostrobin);
(2E)-2-(methoxyimino)-2-{2-[(3E,5E,6E)-5-(methoxyimino)-4,6-dimethyl-2,8-dioxa-3,7-diazanona-3,6-dien-1-yl]phenyl}-N-methylacetamide (orysastrobin);
Methyl (2E)-3-methoxy-2-{2-[6-(trifluoromethyl)-2-pyridyloxymethyl]phenyl}acrylate (picoxystrobin);
Methyl 2-[1-(4-chlorophenyl)pyrazol-3-yloxymethyl]-N-methoxycarbanilate (pyraclostrobin);
Methyl 2-[(1,4-dimethyl-3-phenylpyrazol-5-yl)oxymethyl]-N-methoxycarbanilate (pyrametostrobin);
Methyl (E)-methoxyimino-{(E)-α-[1-(α,α,α-trifluoro-m-tolyl)ethylideneaminooxy]-o-tolyl}-acetate (trifloxystrobin);
(2E)-2-(2-{(E)-[(2E)-3-(2,6-dichlorophenyl)-1-methylprop-2-enylidene]aminooxymethyl}-phenyl)-2-(methoxyimino)-N-methylacetamide (xiwojunan);
   and mixtures thereof.

Azoxystrobin is a particularly preferred strobilurin fungicide.

Suitable oil-insoluble (and water-soluble) active agents include:
amino acids, for example, alginine;
water-soluble fluorescers, for example, Tinopal CBSX;
vitamins, for example, vitamin C;
agrochemicals, for example, glyphosphate;
water-soluble dyes, for example, methyl orange;
water-soluble pharmaceuticals, for example, emtricitabine;
dental/oral health ingredients, for example, sodium monophosphate; and
antimicrobial ingredients, for example, tetracycline.

### Carrier Materials

In the present invention, the carrier material may be selected from suitable GRAS materials or materials contained in an FDA-approved product, one or more inorganic materials, surfactants, polymers, sugars and mixtures thereof.

### Polymeric Carrier Materials

Examples of suitable water-soluble polymeric carrier materials include:
(a) natural polymers (for example naturally occurring gums such as guar gum, alginate, locust bean gum or a polysaccharide such as dextran);
(b) cellulose derivatives for example xanthan gum, xyloglucan, methylcellulose, hydroxyethylcellulose, hydroxyethylmethylcellulose, hydroxypropylcellulose (HPC), hydroxypropylmethylcellulose (HPMC), carboxymethylcellulose and its salts (e.g. the sodium salt—SCMC), or carboxymethylhydroxyethylcellulose and its salts (e.g. the sodium salt);
(c) homopolymers of or copolymers prepared from two or more monomers selected from: vinyl alcohol, acrylic acid, methacrylic acid, acrylamide, methacrylamide, acrylamide methylpropane sulphonates, aminoalkylacrylates, aminoalkyl-methacrylates, hydroxyethylacrylate, hydroxyethylmethylacrylate, vinyl pyrrolidone, vinyl imidazole, vinyl amines, ethyleneglycol and other alkylene glycols, ethylene oxide and other alkylene oxides, ethyleneimine, styrenesulphonates, ethyleneglycolacrylates and ethyleneglycol methacrylate;
(e) cyclodextrins, for example β-cyclodextrin;
(f) mixtures thereof.

When the water-soluble polymeric material is a copolymer it may be a statistical copolymer (also known as a random copolymer), a block copolymer, a graft copolymer or a hyperbranched copolymer. Co-monomers other than those listed above may also be included in addition to those listed if their presence does not destroy the water-soluble or water-dispersible nature of the resulting polymeric material.

Examples of suitable and preferred homopolymers include polyvinylalcohol (PVA), polyacrylic acid, polymethacrylic acid, polyacrylamides (such as poly-N-isopropylacrylamide), polymethacrylamide; polyacrylamines, polymethylacrylamines, (such as polydimethylaminoethylmethacrylate and poly-N-morpholinoethylmethacrylate), polyvinylpyrrolidone (PVP), polystyrenesulphonate, polyvinylimidazole, polyvinylpyridine, poly-2-ethyloxazoline polyethyleneimine and ethoxylated derivatives thereof.

In one aspect, polyethylene glycol (PEG), polyvinylpyrrolidone (PVP), polyvinyl alcohol (PVA), hydroxypropylcellulose (HPC) and hydroxypropylmethylcellulose (HPMC) are preferred water-soluble polymeric carrier materials.

In another aspect, polyvinylpyrrolidone (PVP), polyvinyl alcohol (PVA), hydroxypropylcellulose (HPC) and hydroxypropylmethyl cellulose (HPMC) are preferred water-soluble polymeric carrier materials.

In particular, the water-soluble carrier material may be a polymer selected from polyvinylalcohol (PVA), polyethylene glycol (PEG), polyvinylpyrrolidone (PVP), poly(2-ethyl-2-oxazaline), hydroxypropylcellulose (HPC) and hydroxypropylmethylcellulose (HPMC) and alginate, and mixtures thereof.

Examples of suitable water-insoluble polymeric carrier materials include: polymethacrylates, polyacrylates, polycaprolactone (PCL), polyesters, polystyrenics, polyvinyl ethers, polyvinyl esters, polypropylene glycol, polylactic acid, polyglycolic acid, ethyl cellulose, enteric polymers and copolymers thereof.

When the water-insoluble polymeric material is a copolymer it may be a statistical copolymer (also known as a random copolymer), a block copolymer, a graft copolymer or a hyperbranched copolymer. Comonomers other than those listed above may also be included in addition to those listed if their presence does not destroy the water-insoluble nature of the resulting polymeric material.

Examples of suitable and preferred water-insoluble homopolymers include polyvinylacetate, polybutylmethacrylate (PBMA), polymethylmethacrylate (PMMA), polycaprolactone (PCL) and water-soluble grades of cellulose acetate.

In one aspect, polymethylmethacrylate (PMMA), polycaprolactone (PCL), ethyl cellulose and cellulose acetate phthalate are preferred water-insoluble polymeric carrier materials.

For the avoidance of any doubt, if a polymeric carrier material is used in the present invention, it will be substantially without cross-linking because the purpose of the carrier material is to dissolve on contact with a suitable liquid medium (i.e. aqueous or non-aqueous as the case may be). It is well known that cross-linking has a large effect on physical properties of a polymer because it restricts the relative mobility of the polymer chains, increases molecular weight and causes large scale network formation, thus preventing its dissolution capability. Polystyrene, for example, is soluble in many solvents such as benzene, toluene and carbon tetrachloride. Even with a small amount of cross-linking agent (divinylbenzene, 0.1%) however, the polymer no longer dissolves but only swells.

### Surfactant Carrier Materials

Suitable surfactants carrier materials are preferably solids per-se at temperatures encountered during product storage, i.e. at temperature below 30° C., preferably at temperatures below 40° C. In the alternative, the surfactant may form a solid over an appropriate temperature range in the presence of other materials present in the composition, such as builder salts.

The surfactant may be non-ionic, anionic, cationic, or zwitterionic and depending on whether a water-soluble surfactant or a water-insoluble surfactant (to form a water-soluble composition or a water-insoluble composition respectively) is desired, the skilled person would choose appropriately from the following.

Examples of suitable non-ionic surfactants include ethoxylated triglycerides; fatty alcohol ethoxylates; alkylphenol ethoxylates; fatty acid ethoxylates; fatty amide ethoxylates; fatty amine ethoxylates; sorbitan alkanoates; ethylated sorbitan alkanoates; PEG-ylated sorbitan esters (available under the trade name Tween™); non-PEG-ylated sorbitan esters (available under the trade name Span™); alkyl ethoxylates; block copolymers of ethylene oxide and propylene oxide, i.e. poloxamers (available under the trade name Pluronics™); alkyl polyglucosides; stearol ethoxylates; alkyl polyglycosides; sodium docusate (AOT).

Examples of suitable anionic surfactants include alkylether sulfates; alkylether carboxylates; alkylbenzene sulfonates; alkylether phosphates; dialkyl sulfosuccinates; sarcosinates; alkyl sulfonates; soaps; alkyl sulfates; alkyl carboxylates; alkyl phosphates; paraffin sulfonates; secondary n-alkane sulfonates; alpha-olefin sulfonates; isethionate sulfonates.

Examples of suitable cationic surfactants include fatty amine salts; fatty diamine salts; quaternary ammonium compounds; phosphonium surfactants; sulfonium surfactants.

Examples of suitable zwitterionic surfactants include N-alkyl derivatives of amino acids (such as glycine, betaine, aminopropionic acid); imidazoline surfactants; amine oxides; amidobetaines.

Mixtures of surfactants may be used; in such mixtures there may be individual components which are liquid.

The preferred surfactants are sodium docusate (AOT) and members of each of the Span™ and Tween™.

### Inorganic Carrier Materials

The carrier material may further alternatively be an inorganic material which is neither a surfactant nor a polymer. Simple inorganic salts have been found suitable, particularly in admixture with polymeric and/or surfactant carrier materials as described above. Suitable salts include carbonate, bicarbonates, halides, sulphates, nitrates and acetates, particularly soluble salts of sodium, potassium and magnesium. Preferred materials include sodium carbonate, sodium bicarbonate and sodium sulphate. These materials have the advantage that they are cheap and physiologically acceptable. They are also relatively inert as well as compatible with many materials found in pharmaceutical products.

### Organic Carrier Materials

The carrier material may yet further alternatively be a small organic material which is neither a surfactant, nor a polymer nor an inorganic carrier material. Simple organic sugars have been found to be suitable, particularly in admixture with a polymeric and/or surfactant carrier material as described above. Suitable small organic materials include mannitol, xylitol and inulin, etc.

An improved composition according to the present invention may comprise two or more carrier materials. Mixtures of carrier materials may be advantageous. Preferred mixtures include combinations of surfactants and polymer, for example which mixtures preferably include at least one of:
a) polyvinylalcohol (PVA), polyethylene glycol (PEG), polyvinylpyrrolidone (PVP), hydroxypropylcellulose and hydroxypropylmethyl cellulose (HPMC), alginates and, at least one of;
b) alkoxylated nonionic's (especially the PEG/PPG Pluronic™ materials), alkyl sulphonates, alkyl sulphates (especially SDS), sodium deoxycholate, sodium myristate, sodium docusate, ester surfactants (preferably sorbitan esters of the Span™ and Tween™ types) and cationics (especially cetyltrimethylammonium bromide—CTAB).

### Solvents

In the present invention, the hydrophilic solvent used is preferably water, although any of the following may also be used (either alone or in addition to water): methanol, ethanol, acetone, acetonitrile, N-methylpyrrolidone, dimethyl sulfoxide (DMSO), methylethylketone (MEK), and mixtures thereof.

The non-aqueous solvent used may be selected from the list of solvents available from the International Conference on Harmonization of Technical Requirements for Registration of Pharmaceuticals for Human Use (ICH), more preferably from Class II or Class III of said list. The non-aqueous solvent(s) is especially chosen from one or more from the following group: toluene, cyclohexane, dichloromethane, trichloromethane (chloroform), ethyl acetate, 2-butanone.

### Drying

In the present invention, the drying step may be a spray-drying process, a freeze-drying process or a spray-granulation process. Preferably, the drying step simultaneously removes both the first and second solvents. For the avoidance of doubt, the intention is to remove all, or substantially all, of the first and second solvents from the liquid mixture (e.g. emulsion or single-phase solution) during drying, although it is acknowledged that a de minimis amount may remain.

### Spray-Drying

The most preferred method for drying of the mixture (e.g. emulsion or single-phase solution) is spray-drying. This is particularly effective at removing both the aqueous and non-aqueous volatile components to leave the carrier material, active agent and stabilizing agent behind in a powder form.

For effective spray-drying, we have found that the B-290 Mini Spray Dryer available from Buchi is suitable for laboratory spray-drying. For large-scale spray-drying, a PHARMASD™ spray-dryer available from GEA Niro is suitable.

It is preferable that the drying inlet-temperature should typically be at or above 40° C., possibly above 80° C. and in some circumstances above 100° C., dependent on the temperature-stability of the active agent in use.

### Freeze-Drying

Alternatively however drying may be accomplished by freeze-drying, which brings its own particular benefits, such as in the preparation of aseptic formulations for intravenous administration, or if the active is, e.g. strobilurin fungicide which may otherwise hydrolyse in the presence of water, may suffer oxidative degradation or may exhibit temperature sensitivity.

For effective freeze-drying, we have found that the VirTis bench-top BT4K ZL freeze drying apparatus is suitable for laboratory freeze-drying, whilst a Usifroid freeze-dryer available from Biopharma Process Systems Ltd is suitable for large-scale freeze-drying.

### Spray-Granulation

Further alternatively, drying may be accomplished by using a spray-granulation process, especially a fluidized bed spray granulation/agglomeration process, which again brings its own particular benefits, such as the capability to generate dust-free particles, which can for example be round pellets, which exhibit good flow behaviour, and which are therefore easy to dose. In addition, spray-granulated particles have good dispersibility and solubility, a compact structure and low hygroscopicity.

For effective spray-granulation, we have found the following process conditions to be preferable: an inlet temperature of 40° C. to 250° C., more preferably 55° C. to 130° C.; an outlet temperature of 20° C. to 250° C., more preferably 35° C. to 100° C.; a feed concentration of 1-50% wt dissolved solids, more preferably 10-40% wt dissolved solids.

Notwithstanding the above, spray-drying, freeze-drying and spray-granulation are techniques well-known to those versed in the art.

### Drying Feedstocks

A typical feedstock for drying may comprise:
a) more than 0.1% wt of at least one active agent, for example a water-insoluble active agent;
b) a non-aqueous solvent for the active agent;
c) a carrier material, for example a water-soluble polymer;
d) an aqueous solvent for the carrier material, typically water;
e) a surfactant; and
f) more than 0.1% wt of at least one stabilizing agent, for example a hydrophobic stabilizing agent.

Therefore, in the present invention, preferred feedstocks comprise:
a) more than 0.1% of at least one water-insoluble active agent;
b) at least one non-aqueous solvent selected from dichloromethane, chloroform, ethanol, acetone, and mixtures thereof;
c) a water-soluble polymer selected from polyethylene glycol (PEG), polyvinylalcohol (PVA), polyvinylpyrrolidone (PVP), hydroxypropylcellulose (HPC), hydroxypropylmethylcellulose (HPMC), alginates and mixtures thereof;
d) water;
e) a surfactant selected from PEG co-polymer nonionic's (especially the PEG/PPG Pluronic™ materials), alkyl sulphonates, alkyl sulphates (especially SDS), sodium deoxycholate, sodium mysristate, sodium docusate, ester surfactants (preferably sorbitan esters of the Span™ and Tween™ types) and cationics (especially cetyltrimethylammonium bromide—CTAB) and mixtures thereof; and
f) more than 0.1% wt of at least one hydrophobic stabilizing agent.

The drying feedstocks used in the present invention are preferably either emulsions or single-phase solutions which further preferably do not contain solid matter and in particular preferably do not contain any undissolved active agent or stabilizing agent.

It is particularly preferable that the level of the active agent in the composition should be such that the loading in the dried composition is greater than or equal to 30%, preferably greater than or equal to 40% and most preferably greater than or equal to 50%. Such compositions have the advantages of a small particle size and high effectiveness as discussed above. Similarly, the level of stabilizing agent in the compositions should be such that the loading in the dried composition is greater than or equal to 5%, preferably greater than or equal to 15% and more preferably greater than 20%.

Preferably, the compositions produced after the drying step will comprise the active agent and the stabilizing agent in a weight ratio of from 1:500 to 85:15 (as active agent:stabilizing agent) to 1:100 to 85:15, and further preferably from 1:500 to 1:1 to 1:100 to 1:1. Typical levels of around 10 to 85% active agent plus stabilizing agent nano-co-particles to 90 to 15% carrier material can be obtained by each of spray-drying, freeze-drying and spray-granulation in the final product.

### Second Aspect

According to the present invention there is also provided an improved composition in the form of a nano-dispersion of an active agent with a stabilizing agent in a carrier material obtained by performing the method as hereinbefore described.

### Third Aspect

According to the present invention there is also provided an improved liquid nano-dispersion of an active agent with a stabilizing agent and a carrier material obtained by combining a liquid with the improved composition according to the second aspect of the invention.

The active agent and stabilizing agent nano-co-particles are nano-dispersed in the liquid as the carrier material dissolves in said liquid in sufficiently fine form so that the stabilized active agent behaves like a soluble material in many respects.

The particle size of the active agent and stabilizing agent nano-co-particles in the dry product is preferably such that, on dispersion in a liquid, said particles have a z-average particle size of less than 1000 nm as determined by the Malvern method described herein. It is believed that there is no significant reduction of particle size on dispersion of the dry solid powder form in a liquid medium.

Preferably, the z-average diameter of the nano-disperse form of the active agent and stabilizing agent nano-co-particles is less than 1000 nm, preferably below 800 nm, even more preferably below 500 nm, especially below 200 nm, and most especially below 100 nm. For example, the z-average diameter of the nano-disperse form may be in the range of from 50 to 750 nm, preferably of from 75 to 600 nm.

In relation to the nano-dispersions mentioned above, the preferred active agents, stabilizing agent and carrier materials are as described above.

By applying the present invention significant levels of active agents can be brought into a state which is largely equivalent to true solution, without the otherwise observed problems associated with physical destabilization and particle growth. For example, when a liquid format pharmaceutical (typically water-insoluble) is required, the dry product may be dissolved in an aqueous medium so as to achieve a nano-dispersion comprising up to 20% (and preferably more than 1%, preferably more than 5% and more preferably more than 10%) of the water-insoluble pharmaceutical. Of course the skilled person will appreciate that the actual amount of pharmaceutical in the dispersion will ultimately depend on the manner in which the dispersion is to be administered, e.g. in an injectable form, as an oral liquid, in a form suitable for intravenous administration, for rectal administration, via an intranasal spray, etc.

The improved compositions of the invention, when incorporating a pharmaceutical as the active agent, may be used for the treatment or prophylaxis of a disease or other affliction for which the pharmaceutical was intended.

For a better understanding, the present invention will now be more particularly described by way of non-limiting example only, with reference to the accompanying Figures in which:

FIG. 1 is a plot showing the mean toxicity score on dock ten days after spraying, with the spray applied denoted on the abscissa and the mean score (on a 0 to 5 scale) denoted on the ordinate;

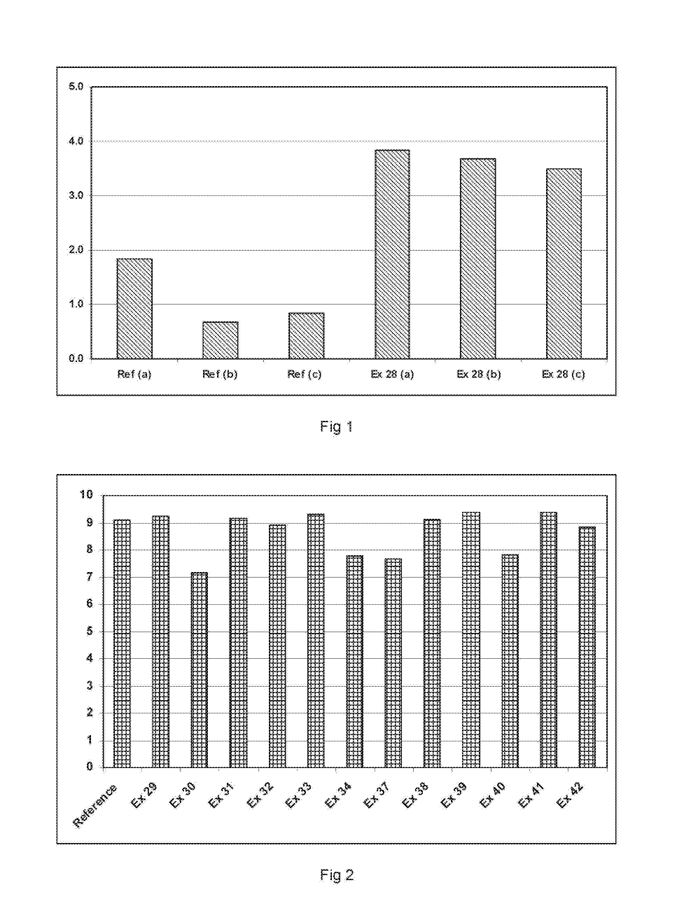

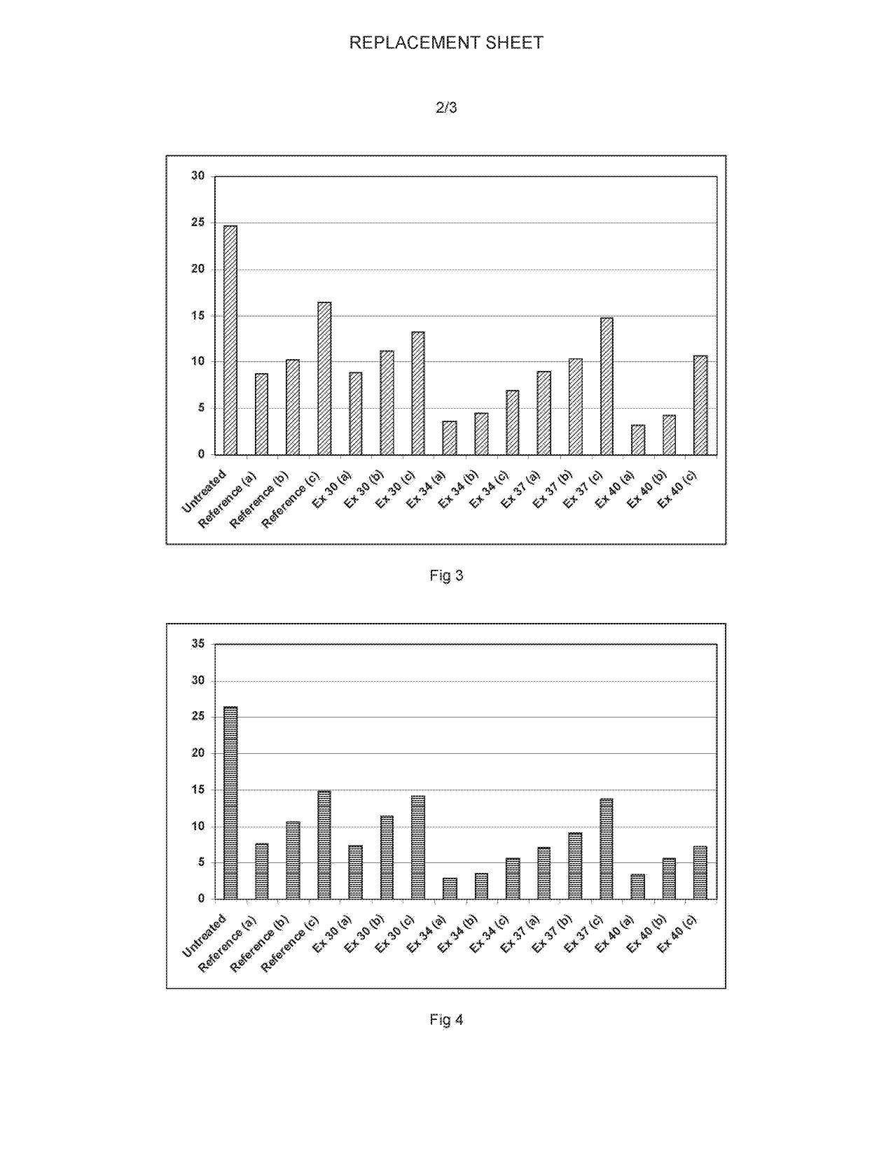

FIG. 2 is a plot showing the radial growth of Fusarium culmorum three days after inoculation with a 4 ppm azoxystrobin formulation, with the spray applied denoted on the abscissa and the mean colony diameter (in millimetres) denoted on the ordinate;

FIG. 3 is a plot showing the curative efficacy of azoxystrobin formulations against wheat brown rust, with the spray applied denoted on the abscissa and the percentage of leaves with rust pustules denoted on the ordinate;

FIG. 4 is a plot showing the preventative efficacy of azoxystrobin formulations against wheat brown rust, with the spray applied denoted on the abscissa and the percentage of leaves with rust pustules denoted on the ordinate; and

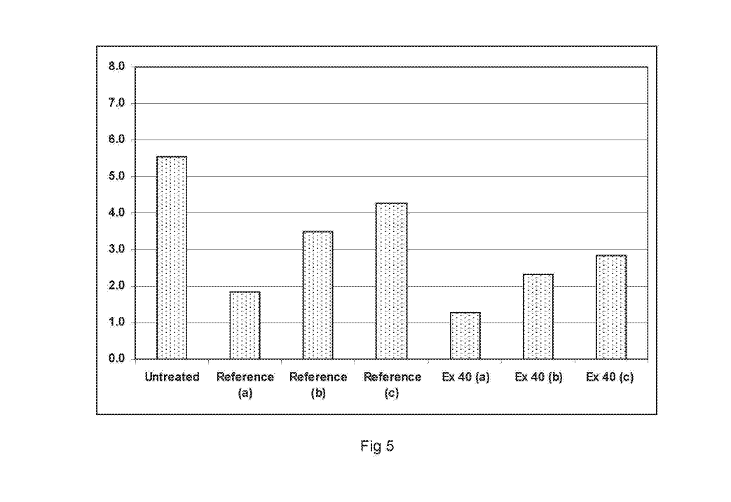

FIG. 5 is a plot showing the field efficacy of azoxystrobin formulations for brown rust control twenty-one days after application at growth stage 65, with the spray applied denoted on the abscissa and the mean leaf area with rust (for forty samples) denoted on the ordinate.

### EXAMPLES

In the following examples, “MW” refers to a weight average molecular weight. All chemicals were obtained from Sigma-Aldrich, unless otherwise specified. Sonication was performed using a Hielscher UP400S sonicator in Examples 1-28 and using a Sonicator™ XL available from Heat Systems in Examples 29-42, and spray-drying with a Buchi Mini-290 spray-dryer, unless otherwise specified. The resultant nano-dispersions were characterized using a Malvern Nano NS particle-sizer, unless otherwise specified.

### Example 1

0.175 g of bifenthrin (active agent) and 0.525 g of polystyrene (stabilizing agent), having a MW of 35 kg/mole were dissolved into 3 ml of dichloromethane (forming an oil phase for an emulsion), whilst 0.30 g of polyvinylalcohol (carrier material), having a MW of 8-9 kg/mole (80% hydrolysed) was dissolved into 9 ml of deionised water (forming an aqueous phase for an emulsion). The oil phase (internal phase) was added into the aqueous phase (continuous phase) and the mixture was sonicated at 50% power for 40 seconds in an ice bath. The resultant emulsion was then spray dried under the following spray-drying conditions:
Inlet Temperature: 105° C.
Atomization Pressure: 3 Bar
Aspiration: 100%
Pump Rate: 15%

The resulting dried powder was dispersed into deionised water at a concentration of 2 mg/ml, and a translucent nano-dispersion was formed. The z-average nano-particle size of the bifenthrin-polystyrene nano-co-particles was 138 nm.

### Example 2

0.175 g of bifenthrin (active agent) and 0.525 g of PMMA (stabilizing agent), having a MW of 15 kg/mole were dissolved into 3 ml of dichloromethane (forming an oil phase for an emulsion), whilst 0.30 g of polyvinylalcohol (carrier material) having a MW of 8-9 kg/mole (80% hydrolysed) was dissolved into 9 ml of deionised water (forming an aqueous phase for an emulsion). The oil phase (internal phase) was added into the aqueous phase (continuous phase) and the mixture was sonicated at 50% power for 40 seconds in an ice bath. The resultant emulsion was then spray dried under the following spray-drying conditions:
Inlet Temperature: 105° C.
Atomization Pressure: 3 Bar
Aspiration: 100%
Pump Rate: 15%

The resulting dried powder was dispersed into deionised water at a concentration of 2 mg/ml, and a translucent nano-dispersion was formed. The z-average nano-particle size of bifenthrin-PMMA nano-co-particles was 116 nm.

### Example 3

0.227 g of abamectin (active agent) and 0.04 g of PMMA (stabilizing agent), having a MW of 15 kg/mole were dissolved into 2 ml of dichloromethane (forming an oil phase for an emulsion), whilst 0.30 g of polyvinylalcohol (carrier material), having a MW of 8-9 kg/mole (80% hydrolysed) was dissolved into 12 ml of deionised water (forming an aqueous phase for an emulsion). The oil phase (internal phase) was added into the aqueous phase (continuous phase) and the mixture was sonicated at 50% power for 50 seconds in an ice bath. The resultant emulsion was then spray dried under the following spray-drying conditions:
Inlet Temperature: 105° C.
Atomization Pressure: 3 Bar
Aspiration: 100%
Pump Rate: 20%

The resulting dried powder was dispersed into deionised water at a concentration of 1500 ppm abamectin (per ml of water), and a milky nano-dispersion was formed. The z-average nano-particle size of abamectin-PMMA nano-co-particles was 223 nm.

### Example 4

0227 g of abamectin (active agent) and 0.04 g of polystyrene (stabilizing agent), having a MW of 35 kg/mole were dissolved into 2 ml of dichloromethane (forming an oil phase for an emulsion), whilst 0.30 g of polyvinylalcohol (carrier material), having a MW of 8-9 kg/mole (80% hydrolysed) was dissolved into 12 ml of deionised water (forming an aqueous phase for an emulsion). The oil phase (internal phase) was added into the aqueous phase (continuous phase) and the mixture was sonicated at 50% power for 50 seconds in an ice bath. The resultant emulsion was then spray dried under the following spray-drying conditions:
Inlet Temperature: 105° C.
Atomization Pressure: 3 Bar
Aspiration: 100%
Pump Rate: 20%

The resulting dried powder was dispersed into deionised water at a concentration of 1500 ppm abamectin (per ml of water), and a milky nano-dispersion was formed. The z-average nano-particle size of abamectin-polystyrene nano-co-particles was 224 nm.

### Example 5—Comparative Example

0.20 g of abamectin (active agent) was dissolved into 2.0 ml of dichloromethane (forming an oil phase for an emulsion), whilst 0.30 g of polyvinylalcohol, having a MW of 8-9 kg/mole (80% hydrolysed), was dissolved into 12 ml of deionised water (forming an aqueous phase for an emulsion). The oil phase (internal phase) was added into the aqueous phase (continuous phase) and the mixture was sonicated at 50% power for 50 seconds in an ice bath. The resultant emulsion was then spray dried under the following spray-drying conditions:
Inlet Temperature: 105° C.
Atomization Pressure: 3 Bar
Aspiration: 100%
Pump Rate: 20%

The resulting dried powder was dispersed into deionised water at a concentration of 1500 ppm abamectin (per ml of water), and a milky nano-dispersion was formed. The z-average nano-particle size of abamectin was 214 nm.

The stability of each of the nano-dispersions formed in Examples 3 and 4 was compared to the stability of the nano-dispersion formed in Comparative Example 5. All three nano-dispersions were frequently monitored for any change in the z-average particle size over a 30-hour period at ambient temperature and ambient pressure, the results of which are shown in Table I below.

TABLE I

| | Particle Size (Z-Average) (nm) | | | | % Increase |
|---|---|---|---|---|---|
| | | After 4 | After 24 | After 30 | in Particle |
| Example | Initially | hours | hours | hours | Size |
| 3 | 223 | 214 | 212 | 210 | 0 |
| 4 | 224 | 218 | 220 | 218 | 0 |
| 5 | 214 | 209 | 312 | 328 | 53 |

As is clearly shown, the initial particle size of the abamectin nano-co-particles and the abamectin only particles is relatively similar when Examples 3 and 4 (with stabilizing agent added) are compared to Example 5 (without any stabilizing agent). However, the longer-term stability of the nano-dispersions in accordance with the invention is much improved compared to a prior art nano-dispersion, with which a massive 53% increase in z-average particle size is observed in just a 30-hour window.

### Example 6

50 mg of tebuconazole (active agent) and 50 mg of safflower seed oil (stabilizing agent), having a CAS No. 8001-23-8 were dissolved in 2 ml of toluene (forming an oil phase for an emulsion), whilst 355.6 mg of polyvinylalcohol (carrier material), having a MW of 9-10 kg/mole and 44.4 mg of SDS (sourced from VWR) were dissolved into 20 ml of deionized water (forming an aqueous phase for an emulsion). The oil phase (internal phase) was added into the aqueous phase (continuous phase) and the mixture was sonicated at 100% power for 2 minutes. The resultant emulsion was then spray-dried under the following spray-drying conditions:
Inlet Temperature: 150° C.
Pump Rate: 15%

The resulting dried white powder was dispersed into deionised water at a concentration of 10 mg/ml. The z-average nano-particle size of the tebuconazole-safflower seed oil nano-co-particles was 227 nm.

### Example 7

50 mg of tebuconazole (active agent) and 50 mg of paraffin oil (stabilizing agent), having a CAS No. 8012-95-1 (sourced from Riedel-de H\dot{a}ën) were dissolved in 2 ml of toluene (forming an oil phase for an emulsion), whilst 355.6 mg of polyvinylalcohol (carrier material), having a MW of 9-10 kg/mole and 44.4 mg of SDS (sourced from VWR) were dissolved into 20 ml of deionized water (forming an aqueous phase for an emulsion). The oil phase (internal phase) was added into the aqueous phase (continuous phase) and the mixture was sonicated at 100% power for 2 minutes. The resultant emulsion was then spray-dried under the following spray-drying conditions:
Inlet Temperature: 150° C.
Pump Rate: 15%

The resulting dried white powder was dispersed into deionised water at a concentration of 10 mg/ml. The z-average nano-particle size of the tebuconazole-paraffin oil nano-co-particles was 189 nm.

### Example 8

50 mg of tebuconazole (active agent) and 50 mg of polypropylene glycol (stabilizing agent), having a MW of 400 kg/mole and a CAS No. 25322/6914 were dissolved in 2 ml of toluene (forming an oil phase for an emulsion), whilst 355.6 mg of polyvinylalcohol (carrier material), having a MW of 9-10 kg/mole and 44.4 mg of SDS (sourced from VWR) were dissolved into 20 ml of deionized water (forming an aqueous phase for an emulsion). The oil phase (internal phase) was added into the aqueous phase (continuous phase) and the mixture was sonicated at 100% power for 2 minutes. The resultant emulsion was then spray-dried under the following spray-drying conditions:
Inlet Temperature: 150° C.
Pump Rate: 15%

The resulting dried white powder was dispersed into deionised water at a concentration of 10 mg/ml. The z-average nano-particle size of the tebuconazole-polypropylene glycol nano-co-particles was 235 nm.

### Example 9

50 mg of tebuconazole (active agent) and 50 mg of paraffin wax (stabilizing agent), having a CAS No. 8002-74-2 (sourced from Fluka) were dissolved in 2 ml of toluene (forming an oil phase for an emulsion), whilst 355.6 mg of polyvinylalcohol (carrier material), having a MW of 9-10 kg/mole and 44.4 mg of SDS (sourced from VWR) were dissolved into 20 ml of deionized water (forming an aqueous phase for an emulsion). The oil phase (internal phase) was added into the aqueous phase (continuous phase) and the mixture was sonicated at 100% power for 2 minutes. The resultant emulsion was then spray-dried under the following spray-drying conditions:
Inlet Temperature: 150° C.
Pump Rate: 15%

The resulting dried white powder was dispersed into deionised water at a concentration of 10 mg/ml. The z-average nano-particle size of the tebuconazole-paraffin wax nano-co-particles was 253 nm.

### Example 10

50 mg of tebuconazole (active agent) and 50 mg of hexadecyltrimethoxysilane (stabilizing agent), having a MW of 347 kg/mole were dissolved in 2 ml of toluene (forming an oil phase for an emulsion), whilst 355.6 mg of polyvinylalcohol (carrier material), having a MW of 9-10 kg/mole and 44.4 mg of SDS (sourced from VWR) were dissolved into 20 ml of deionized water (forming an aqueous phase for an emulsion). The oil phase (internal phase) was added into the aqueous phase (continuous phase) and the mixture was sonicated at 100% power for 2 minutes. The resultant emulsion was then spray-dried under the following spray-drying conditions:
Inlet Temperature: 150° C.
Pump Rate: 15%

The resulting dried white powder was dispersed into deionised water at a concentration of 10 mg/ml. The z-average nano-particle size of the tebuconazole-hexadecyltrimethoxysilane nano-co-particles was 194 nm.

### Example 11

0.5 ml of a solution of fipronil (active agent) (100 mg/ml in 7:3; DCM:MEK) was placed in a 30 ml sample vial and to this 0.5 ml of a solution of polystyrene (stabilizing agent) (100 mg/ml in 7:3; DCM:MEK), having a MW of 230 kg/mole was added forming an oil phase for an emulsion. 7 ml of a solution of PVP (carrier material) (50 mg/ml in deionised water), 1 ml of a solution of SDS (50 mg/ml in deionised water) and 1 ml of deionised water were then added sequentially to the oil phase to form a mixture. The mixture was cooled on ice for 30 minutes and then sonicated at 50% power for 45 seconds. The resultant emulsion was then immediately spray-dried under the following spray-drying conditions:
Inlet Temperature: 160° C.
Atomization Pressure: 3 Bar
Aspiration: 100%

The resulting dried powder was dispersed into deionised water to form a nano-dispersion. The z-average nano-particle size of the fipronil-polystyrene nano-co-particles was 93 nm, and the polydispersity index was 0.233.

### Example 12

0.5 ml of a solution of fipronil (active agent) (100 mg/ml in 7:3; DCM:MEK) was placed in a 30 ml sample vial and to this 0.5 ml of a solution of PMMA (stabilizing agent) (100 mg/ml in 7:3; DCM:MEK), having a MW of 67 kg/mole was added forming an oil phase for an emulsion. 7 ml of a solution of PVP (carrier material) (50 mg/ml in deionised water), 1 ml of a solution of SDS (50 mg/ml in deionised water) and 1 ml of deionised water were then added sequentially to the oil phase to form a mixture. The mixture was cooled on ice for 30 minutes and then sonicated at 50% power for 45 seconds. The resultant emulsion was then immediately spray-dried under the following spray-drying conditions:
Inlet Temperature: 160° C.
Atomization Pressure: 3 Bar
Aspiration: 100%
Pump Rate: 15%

The resulting dried powder was dispersed into deionised water to form a nano-dispersion. The z-average nano-particle size of the fipronil-PMMA nano-co-particles was 78 nm, and the polydispersity index was 0.23.

### Example 13

0.5 ml of a solution of fipronil (active agent) (100 mg/ml in 7:3; DCM:MEK) was placed in a 30 ml sample vial and to this 0.5 ml of a solution of PBMA (stabilizing agent) (100 mg/ml in 7:3; DCM:MEK), having a MW of 337 kg/mole, was added forming an oil phase for an emulsion. 7 ml of a solution of PVP (carrier material) (50 mg/ml in deionised water), 1 ml of a solution of SDS (50 mg/ml in deionised water) and 1 ml of deionised water were then added sequentially to the oil phase to form a mixture. The mixture was cooled on ice for 30 minutes and then sonicated at 50% power for 45 seconds. The resultant emulsion was then immediately spray-dried under the following spray-drying conditions:
Inlet Temperature: 160° C.
Atomization Pressure: 3 Bar
Aspiration: 100%

The resulting dried powder was dispersed into deionised water to form a nano-dispersion. The z-average nano-particle size of the fipronil-PBMA nano-co-particles was 89 nm, and the polydispersity index was 0.186.

### Example 14

0.5 ml of a solution of fipronil (active agent) (100 mg/ml in 7:3; DCM:MEK) was placed in a 30 ml sample vial and to this 0.5 ml of a solution of PVAC (stabilizing agent) (100 mg/ml in 7:3; DCM:MEK), having a MW of 83 kg/mole, was added forming an oil phase for an emulsion. 7 ml of a solution of PVP (carrier material) (50 mg/ml in deionised water), 1 ml of a solution of SDS (50 mg/ml in deionised water) and 1 ml of deionised water were then added sequentially to the oil phase to form a mixture. The mixture was cooled on ice for 30 minutes and then sonicated at 50% power for 45 seconds. The resultant emulsion was then immediately spray-dried under the following spray-drying conditions:
Inlet Temperature: 160° C.
Atomization Pressure: 3 Bar
Aspiration: 100%
Pump Rate: 15%

The resulting dried powder was dispersed into deionised water to form a nano-dispersion. The z-average nano-particle size of the fipronil-PVAC nano-co-particles was 105 nm, and the polydispersity index was 0.179.

### Example 15—Comparative Example

1 ml of a solution of fipronil (active agent) (100 mg/ml in 7:3; DCM:MEK) was placed in a 30 ml sample vial as the oil phase for an emulsion. 7 ml of a solution of PVP (carrier material) (50 mg/ml in deionised water), 1 ml of a solution of SDS (50 mg/ml in deionised water) and 1 ml of deionised water were then added sequentially to the oil phase to form a mixture. The mixture was then sonicated at 50% power for 15 seconds. The resultant emulsion was then immediately spray-dried under the following spray-drying conditions:
Inlet Temperature: 160° C.
Atomization Pressure: 3 Bar
Aspiration: 100%
Pump Rate: 15%

The resulting dried powder was dispersed into deionised water to form a nano-dispersion. The z-average nano-particle size of the fipronil nanoparticles was 1037 nm, and the polydispersity index was 0.701.

### Example 16—Comparative Example

1 ml of a solution of fipronil (active agent) (100 mg/ml in 7:3; DCM:MEK) was placed in a 30 ml sample vial as the oil phase for an emulsion. 7 ml of a solution of PVP (carrier material) (50 mg/ml in deionised water), 1 ml of a solution of SDS (50 mg/ml in deionised water) and 1 ml of deionised water were then added sequentially to the oil phase to form a mixture. The mixture was then sonicated at 50% power for 15 seconds. The resultant emulsion was then immediately spray-dried under the following spray-drying conditions:
Inlet Temperature: 90° C.
Atomization Pressure: 3 Bar
Aspiration: 100%
Pump Rate: 15%

The resulting dried powder was dispersed into deionised water to form a nano-dispersion. The z-average nano-particle size of the fipronil nanoparticles was 643.5 nm, and the polydispersity index was 0.419.

### Example 17

0.5 ml of a solution of fipronil (active agent) (200 mg/ml in 7:3; DCM:MEK) was placed in a 30 ml sample vial and to this 0.5 ml of a solution of PMMA (stabilizing agent) (200 mg/ml in 7:3; DCM:MEK), having a MW of 67 kg/mole, was added forming an oil phase for an emulsion. 5 ml of a solution of PVP (carrier material) (50 mg/ml in deionised water), 1 ml of a solution of SDS (50 mg/ml in deionised water) and 3 ml of deionised water were then added sequentially to the oil phase to form a mixture. The mixture was then sonicated at 50% power for 15 seconds. The resultant emulsion was then immediately spray-dried under the following spray-drying conditions:
Inlet Temperature: 160° C.
Atomization Pressure: 3 Bar
Aspiration: 100
Pump Rate: 15%

The resulting dried powder was dispersed into deionised water to form a nano-dispersion. The z-average nano-particle size of the fipronil-PMMA nano-co-particles was 359.6 nm, and the polydispersity index was 0.496.

The stability of the nano-dispersion formed in Example 17 was compared to the stability of each of the nano-dispersions formed in Comparative Examples 15 and 16. All three nano-dispersions were frequently monitored for any change in the z-average particle size over a particular time period at ambient temperature and ambient pressure, the results of which are shown in Table II below.

TABLE II

| | Particle Size (Z-Average) (nm) | | % Increase |
|---|---|---|---|
| | | After 2.5 | in Particle |
| Example | Initially | hours | Size |
| 15 | 1037 | 2041 | 97 |
| 16 | 643.5 | 1488 | 131 |
| 17 | 359.6 | 234.1 | −35 |

As is clearly shown, the initial particle size of the fipronil nano-co-particles is much smaller than that of the fipronil only particles. Furthermore, the longer-term stability of the nano-dispersion (of Example 17) in accordance with the invention is much improved compared to the prior art nano-dispersions (of Comparative Examples 15 and 16), with which a massive 97% and 131% increase respectively in z-average particle size is observed in just a 2.5-hour window. It should also be noted that in Example 17, the z-average particle size of the fipronil nanoparticles actually reduces by 35% in the first 2.5 hours, which clearly illustrates the importance of accurately recording the time after particle formation at which z-average is measured.

### Example 18—Comparative Example

1 ml of a solution of fipronil (active agent) (100 mg/ml in 7:3; DCM:MEK) was placed in a 30 ml sample vial as the oil phase for an emulsion. 7 ml of a solution of PVP (carrier material) (50 mg/ml in deionised water), 1 ml of a solution of SDS (50 mg/ml in deionised water) and 1 ml of deionised water were then added sequentially to the oil phase to form a mixture. The mixture was then cooled on ice for 30 minutes before being sonicated at 50% power for 45 seconds. The resultant emulsion was then immediately spray-dried under the following spray-drying conditions:
Inlet Temperature: 90° C.
Atomization Pressure: 3 Bar
Aspiration: 100%
Pump Rate: 15%

The resulting dried powder was dispersed into deionised water to form a nano-dispersion. The z-average nano-particle size of the fipronil nanoparticles was 753.32 nm, and the polydispersity index was 0.507.

### Example 19

0.5 ml of a solution of fipronil (active agent) (200 mg/ml in 7:3; DCM:MEK) was placed in a 30 ml sample vial and to this 0.5 ml of a solution of PMMA (stabilizing agent) (200 mg/ml in 7:3; DCM:MEK), having a MW of 67 kg/mole, was added forming an oil phase for an emulsion. 5 ml of a solution of PVP (carrier material) (50 mg/ml in deionised water), 1 ml of a solution of SDS (50 mg/ml in deionised water) and 3 ml of deionised water were then added sequentially to the oil phase to form a mixture. The mixture was then cooled on ice for 30 minutes before being sonicated at 50% power for 45 seconds. The resultant emulsion was then immediately spray-dried under the following spray-drying conditions:
Inlet Temperature: 160° C.
Atomization Pressure: 3 Bar
Aspiration: 100%
Pump Rate: 15%

The resulting dried powder was dispersed into deionised water to form a nano-dispersion. The z-average nano-particle size of the fipronil-PMMA nano-co-particles was 192.8 nm, and the polydispersity index was 0.259.

The stability of the nano-dispersion formed in Example 19 was compared to the stability of the nano-dispersion formed in Comparative Example 18. Both nano-dispersions were frequently monitored for any change in the z-average particle size over a particular time period at ambient temperature and ambient pressure, the results of which are shown in Table III below.

TABLE III

Particle Size (Z-Average) (nm)

| | | After 3 |
|---|---|---|
| Example | Initially | hours |
| 18 | 753.2 | 737.0 |
| 19 | 192.8 | 192.8 |

As is clearly shown, the initial particle size of the fipronil nano-co-particles is much smaller than that of the fipronil only particles (˜193 nm as compared to ˜753 nm respectively), with the particle size remaining constant after 3 hours for the fipronil nano-co-particles, and reducing slightly for the prior art nano-dispersion. After 3 hours however, the particle size of the fipronil only particles is still much larger (by almost a factor of four) than the particle size of the fipronil nano-co-particles.

### Example 20—Comparative Example

1 ml of a solution of fipronil (active agent) (40 mg/ml in 7:3; DCM:MEK) was placed in a 30 ml sample vial as the oil phase for an emulsion. 6.4 ml of a solution of PVP (carrier material) (50 mg/ml in deionised water), 0.8 ml of a solution of SDS (50 mg/ml in deionised water) and 1.8 ml of deionised water were then added sequentially to the oil phase to form a mixture. The mixture was then sonicated at 50% power for 15 seconds. The resultant emulsion was then immediately spray-dried under the following spray-drying conditions:
Inlet Temperature: 90° C.
Atomization Pressure: 3 Bar
Aspiration: 100%
Pump Rate: 15%

The resulting dried powder was dispersed into deionised water to form a nano-dispersion. The z-average nano-particle size of the fipronil nanoparticles was 882.7 nm, and the polydispersity index was 0.370.

### Example 21

0.4 ml of a solution of fipronil (active agent) (200 mg/ml in 7:3; DCM:MEK) was placed in a 30 ml sample vial and to this 0.6 ml of a solution of PMMA (stabilizing agent) (66.6 mg/ml in 7:3; DCM:MEK), having a MW of 67 kg/mole, was added forming an oil phase for an emulsion. 5.6 ml of a solution of PVP (carrier material) (50 mg/ml in deionised water), 0.8 ml of a solution of SDS (50 mg/ml in deionised water) and 2.6 ml of deionised water were then added sequentially to the oil phase to form a mixture. The mixture was then sonicated at 50% power for 15 seconds. The resultant emulsion was then immediately spray-dried under the following spray-drying conditions:
Inlet Temperature: 160° C.
Atomization Pressure: 3 Bar
Aspiration: 100%
Pump Rate: 15%

The resulting dried powder was dispersed into deionised water to form a nano-dispersion. The z-average nano-particle size of the fipronil-PMMA nano-co-particles was 231.5 nm, and the polydispersity index was 0.201.

The stability of the nano-dispersion formed in Example 21 was compared to the stability of the nano-dispersion formed in Comparative Example 20. Both nano-dispersions were frequently monitored for any change in the z-average particle size over a particular time period at ambient temperature and ambient pressure, the results of which are shown in Table IV below.

TABLE IV

| | Particle Size (Z-Average) (nm) | | | % Increase |
|---|---|---|---|---|
| | | After 3 | After 6.5 | in Particle |
| Example | Initially | hours | hours | Size |
| 20 | 882.7 | 806.9 | 1023 | 16 (to 6.5 |
| | | | | hours) |
| 21 | 231.5 | 216.5 | 239.9 | 4 (to 6.5 |
| | | | | hours) |

As is clearly shown, the initial particle size of the fipronil nano-co-particles is much smaller than that of the fipronil only particles (˜232 nm as compared to −883 nm respectively). In both cases, the particle size reduces slightly when measured after 3 hours, and then increases again when measured after 6.5 hours, however the fipronil only particles show a 16% increase in particle size over the 6.5 hour period, whereas the fipronil nano-co-particles only show a 4% increase in particle size over the same period. Furthermore, after 6.5 hours the particle size of the fipronil only particles is still much larger (by over a factor of four) than the particle size of the fipronil nano-co-particles.

### Example 22

4 ml of a solution of prochloraz (active agent) (100 mg/ml in DCM) was made to a total volume of 5.20 ml by adding 1.2 ml of a solution of PBMA (stabilizing agent) (100 mg/ml in DCM), having a MW of 337 kg/mole, forming an oil phase for an emulsion. In parallel, 4.8 ml of an aqueous solution of PVA (100 mg/ml in deionised water), having a MW of 10 kg/mole (80% hydrolysed), was made up to a volume of 25 ml with deionised water for an aqueous phase for an emulsion. The oil phase was added to the aqueous phase in a ratio of 1:4.8 (oil:aqueous) to form a mixture and then chilled for 30 minutes in an ice bath. The chilled mixture was then sonicated at 100% power for 90 seconds. The resultant emulsion was then immediately spray-dried under the following spray-drying conditions:
Inlet Temperature: 102° C.
Atomization Pressure: 3 Bar
Aspiration: 100%
Pump Rate: 10%

The resulting dried powder was dispersed into deionised water by adding 20 mg of the powder into 2 ml of water, and then subsequently agitated using a vortex mixer until all the large particulates had dispersed to form a nano-dispersion. The z-average nano-particle size of the prochloraz-PBMA nano-co-particles was 312 nm.

### Example 23

4 ml of a solution of prochloraz (active agent) (100 mg/ml in DCM) was made to a total volume of 5.20 ml by adding 1.2 ml of a solution of polystyrene (stabilizing agent) (100 mg/ml in DCM), having a MW of 35 kg/mole, forming an oil phase for an emulsion. In parallel, 4.8 ml of an aqueous solution of PVA (100 mg/ml in deionised water), having a MW of 10 kg/mole (80% hydrolysed), was made up to a volume of 25 ml with deionised water for an aqueous phase for an emulsion. The oil phase was added to the aqueous phase in a ratio of 1:4.8 (oil:aqueous) to form a mixture and then chilled for 30 minutes in an ice bath. The chilled mixture was then sonicated at 100% power for 90 seconds. The resultant emulsion was then immediately spray-dried under the following spray-drying conditions:
Inlet Temperature: 102° C.
Atomization Pressure: 3 Bar
Aspiration: 100%
Pump Rate: 10%

The resulting dried powder was dispersed into deionised water by adding 20 mg of the powder into 2 ml of water, and then subsequently agitated using a vortex mixer until all the large particulates had dispersed to form a nano-dispersion. The z-average nano-particle size of the prochloraz-polystyrene nano-co-particles was 264 nm.

### Example 24

4 ml of a solution of prochloraz (active agent) (100 mg/ml in DCM) was made to a total volume of 5.20 ml by adding 1.2 ml of a solution of PMMA (stabilizing agent) (100 mg/ml in DCM), having a MW of 15 kg/mole, forming an oil phase for an emulsion. In parallel, 4.8 ml of an aqueous solution of PVA (100 mg/ml in deionised water), having a MW of 10 kg/mole (80% hydrolysed), was made up to a volume of 25 ml with deionised water for an aqueous phase for an emulsion. The oil phase was added to the aqueous phase in a ratio of 1:4.8 (oil:aqueous) to form a mixture and then chilled for 30 minutes in an ice bath. The chilled mixture was then sonicated at 100% power for 90 seconds. The resultant emulsion was then immediately spray-dried under the following spray-drying conditions:
Inlet Temperature: 102° C.
Atomization Pressure: 3 Bar
Aspiration: 100%
Pump Rate: 10%

The resulting dried powder was dispersed into deionised water by adding 20 mg of the powder into 2 ml of water, and then subsequently agitated using a vortex mixer until all the large particulates had dispersed to form a nano-dispersion. The z-average nano-particle size of the prochloraz-PMMA nano-co-particles was 217 nm.

### Example 25

4 ml of a solution of prochloraz (active agent) (100 mg/ml in DCM) was made to a total volume of 5.20 ml by adding 1.2 ml of a solution of PMMA (stabilizing agent) (100 mg/ml in DCM), having a MW of 120 kg/mole, forming an oil phase for an emulsion. In parallel, 4.8 ml of an aqueous solution of PVA (100 mg/ml in deionised water), having a MW of 10 kg/mole (80% hydrolysed), was made up to a volume of 25 ml with deionised water for an aqueous phase for an emulsion. The oil phase was added to the aqueous phase in a ratio of 1:4.8 (oil:aqueous) to form a mixture and then chilled for 30 minutes in an ice bath. The chilled mixture was then sonicated at 100% power for 90 seconds. The resultant emulsion was then immediately spray-dried under the following spray-drying conditions:
Inlet Temperature: 102° C.
Atomization Pressure: 3 Bar
Aspiration: 100%
Pump Rate: 10%

The resulting dried powder was dispersed into deionised water by adding 20 mg of the powder into 2 ml of water, and then subsequently agitated using a vortex mixer until all the large particulates had dispersed to form a nano-dispersion. The z-average nano-particle size of the prochloraz-PMMA nano-co-particles was 239 nm.

### Example 26

4 ml of a solution of prochloraz (active agent) (100 mg/ml in DCM) was made to a total volume of 5.20 ml by adding 1.2 ml of a solution of polystyrene 140 (stabilizing agent) (100 mg/ml in DCM), having a MW of 230 kg/mole, forming an oil phase for an emulsion. In parallel, 4.8 ml of an aqueous solution of PVA (100 mg/ml in deionised water), having a MW of 10 kg/mole (80% hydrolysed), was made up to a volume of 25 ml with deionised water for an aqueous phase for an emulsion. The oil phase was added to the aqueous phase in a ratio of 1:4.8 (oil:aqueous) to form a mixture and then chilled for 30 minutes in an ice bath. The chilled mixture was then sonicated at 100% power for 90 seconds. The resultant emulsion was then immediately spray-dried under the following spray-drying conditions:
Inlet Temperature: 102° C.
Atomization Pressure: 3 Bar
Aspiration: 100%
Pump Rate: 10%

The resulting dried powder was dispersed into deionised water by adding 20 mg of the powder into 2 ml of water, and then subsequently agitated using a vortex mixer until all the large particulates had dispersed to form a nano-dispersion. The z-average nano-particle size of the prochloraz-polystyrene nano-co-particles was 315 nm.

### Example 27—Comparative Example

6 ml of an aqueous solution of PVA (carrier material) (50 mg/ml in deionised water), having a MW of 9-10 kg/mole, was made to a total volume of 10 ml by adding 4 ml of deionised water. To this aqueous solution, 2 ml of an organic solution of prochloraz (active agent) (100 mg/ml in DMC) were added. The two-phase liquid was then sonicated at 50% power for 35 seconds to form an emulsion, which was then immediately spray-dried under the following spray-drying conditions:
Inlet Temperature: 100° C.
Atomization Pressure: 3 Bar
Aspiration: 100%
Pump Rate: 10%

The resulting dried powder was dispersed into deionised water by adding 20 mg of the powder into 2 ml of water, and then subsequently agitated using a vortex mixer until all the large particulates had dispersed to form a nano-dispersion. The z-average nano-particle size of the prochloraz nanoparticles was 422 nm.

As can be seen, the initial z-average particle size of the prochloraz-only nanoparticles is 422 nm in Comparative Example 27, whilst in all the examples of the invention in which prochloraz is the active agent (Examples 22-26), the initial z-average particle size of the prochloraz-stabilizing agent nano-co-particles are less than 320 nm (the largest being 315 nm), and typically less than 250 nm.

### Example 28

An organic solution of DCM (2.6 ml), diflufenican (active agent) (0.2 g) and polystyrene (stabilizing agent) (0.06 g), having an MW of 35 kg/mole, was added to an aqueous solution of deionised water (12.5 ml), PVA (carrier material) 80% hydrolysed (0.165 g), SDS 0.025 g and sodium myristate (0.05 g). The two-phase solution was sonicated at 100% intensity for 20 seconds. The resultant emulsion was spray dried under the following spray-drying conditions:
Inlet Temperature: 100° C.
Atomization Pressure: 3 Bar
Aspiration: 100%
Pump Rate: 10%

The resulting dried powder was dispersed into deionised water (10 mg/ml) and then subsequently agitated using a vortex mixer until all the large particulates had dispersed to form a nano-dispersion. The z-average nano-particle size of the diflufenican-polystyrene nano-co-particles was 479 nm.

### Efficacy Test Results

A nano-suspension formulation of diflufenican (from Example 28) was compared with a reference formulation made with commercially available Hurricane SC™ (Reference). Dock plants were treated with the reference formulation at equivalent field rates* of (a) 1.0 L ha⁻¹ (full field rate) and at lower equivalent rates of (b) 0.5 and (c) 0.25 L ha⁻¹, to emphasise any differences in disease control efficacy. The nano-suspension formulation was applied to give the same dose of active ingredient as Hurricane SC™ at these three equivalent dosages. An equivalent field rate is calculated on the basis that the full field rate is equivalent to 250 mL of Hurricane SC™ made up in 200 L tap water.

Six replicate pots, with three dock seeds planted pot, were treated in a single spray application with each formulation three weeks after the seeds were sown. Toxicity assessments were then conducted ten days later, visually, using a standard visual key to assist evaluation. The mean toxicity score results are shown in FIG. 1.

SCORING SYSTEM

| % leaf necrosis | Mean Toxicity Score |
|---|---|
| 0 | 0 |
| 1-20 | 1 |
| 21-40 | 2 |
| 41-60 | 3 |
| 61-80 | 4 |
| 81-100 | 5 |

The lower the value of mean toxicity score, the more efficacious a particular formulation is at destroying dock plants. As can be seen from FIG. 1, the formulation of Example 28 is much more effective a inducing necrosis (evidenced by the higher mean scores) in the plants as compared to the dock plants treated with the Hurricane SC™ (Reference) formulation. Furthermore, it is clear that Example 28 formulation performs better than the Hurricane SC™ (Reference) formulation across all three treatment regimes (a), (b) and (c).

### Example 29

0.225 g of azoxystrobin (strobilurin fungicide) and 0.025 g of PMMA (stabilizing agent), having a MW of 15 kg/mole, were dissolved into 2 ml dichloromethane (forming an oil phase for an emulsion), whilst 0.30 g of polyvinylalcohol (carrier material), having a MW of 8-9 kg/mole (80% hydrolysed), was dissolved into 9 ml of deionised water (forming an aqueous phase for an emulsion). The oil phase (internal phase) was added into the aqueous phase (continuous phase) and the mixture was sonicated at level 5 for 55 seconds in an ice bath. The resultant emulsion was then spray dried under the following spray-drying conditions:
Inlet Temperature: 110° C.
Atomization Pressure: 3 Bar
Aspiration: 100%
Pump rate: 15%

The resulting dried powder was dispersed into deionised water at a concentration of 3,000 ppm azoxystrobin and a translucent nano-dispersion was formed. The z-average nano-particle size of the azoxystrobin-PMMA nano-co-particles was 278 nm.

### Example 30

0.225 g of azoxystrobin (strobilurin fungicide) and 0.025 g of PMMA-co-MAA (stabilizing agent), having a MW of 34 kg/mole, were dissolved into 2 ml dichloromethane (forming an oil phase for an emulsion), whilst 0.30 g of polyvinylalcohol (carrier material), having a MW of 8-9 kg/mole (80% hydrolysed), was dissolved into 9 ml of deionised water (forming an aqueous phase for an emulsion). The oil phase (internal phase) was added into the aqueous phase (continuous phase) and the mixture was sonicated at level 5 for 55 seconds in an ice bath. The resultant emulsion was then spray dried under the following spray-drying conditions:
Inlet Temperature: 110° C.
Atomization Pressure: 3 Bar
Aspiration: 100%
Pump rate: 15%

The resulting dried powder was dispersed into deionised water at a concentration of 3,000 ppm azoxystrobin and a translucent nano-dispersion was formed. The z-average nano-particle size of the azoxystrobin-PMMA-co-MAA nano-co-particles was 288 nm.

### Example 31

0.225 g of azoxystrobin (strobilurin fungicide) and 0.025 g of PMMA (stabilizing agent), having a MW of 120 kg/mole, were dissolved into 2 ml dichloromethane (forming an oil phase for an emulsion), whilst 0.30 g of polyvinylalcohol (carrier material), having a MW of 8-9 kg/mole (80% hydrolysed), was dissolved into 9 ml of deionised water (forming an aqueous phase for an emulsion). The oil phase (internal phase) was added into the aqueous phase (continuous phase) and the mixture was sonicated at level 5 for 55 seconds in an ice bath. The resultant emulsion was then spray dried under the following spray-drying conditions:
Inlet Temperature: 110° C.
Atomization Pressure: 3 Bar
Aspiration: 100%
Pump rate: 15%

The resulting dried powder was dispersed into deionised water at a concentration of 3,000 ppm azoxystrobin and a translucent nano-dispersion was formed. The z-average nano-particle size of the azoxystrobin-PMMA nano-co-particles was 291 nm.

### Example 32

0.227 g of azoxystrobin (strobilurin fungicide) and 0.04 g of polystyrene (stabilizing agent), having a MW of 35 kg/mole, were dissolved into 2.25 ml dichloromethane (forming an oil phase for an emulsion), whilst 0.30 g of polyvinylalcohol (carrier material), having a MW of 8-9 kg/mole (80% hydrolysed), was dissolved into 9 ml of deionised water (forming an aqueous phase for an emulsion). The oil phase (internal phase) was added into the aqueous phase (continuous phase) and the mixture was sonicated at level 5 for 55 seconds in an ice bath. The resultant emulsion was then spray dried under the following spray-drying conditions:
Inlet Temperature: 110° C.
Atomization Pressure: 3 Bar
Aspiration: 100%
Pump rate: 15%

The resulting dried powder was dispersed into deionised water at a concentration of 3,000 ppm azoxystrobin and a translucent nano-dispersion was formed. The z-average nano-particle size of the azoxystrobin-polystyrene nano-co-particles was 282 nm.

### Example 33

0.227 g of azoxystrobin (strobilurin fungicide) and 0.04 g of PBMA (stabilizing agent), having a MW of 35 kg/mole, were dissolved into 2.25 ml dichloromethane (forming an oil phase for an emulsion), whilst 0.30 g of polyvinylalcohol (carrier material), having a MW of 8-9 kg/mole (80% hydrolysed), was dissolved into 9 ml of deionised water (forming an aqueous phase for an emulsion). The oil phase (internal phase) was added into the aqueous phase (continuous phase) and the mixture was sonicated at level 5 for 55 seconds in an ice bath. The resultant emulsion was then spray dried under the following spray-drying conditions:
Inlet Temperature: 110° C.
Atomization Pressure: 3 Bar
Aspiration: 100%
Pump rate: 15%

The resulting dried powder was dispersed into deionised water at a concentration of 3,000 ppm azoxystrobin and a translucent nano-dispersion was formed. The z-average nano-particle size of the azoxystrobin-PBMA nano-co-particles was 314 nm.

### Example 34

0.40 g of azoxystrobin (strobilurin fungicide) and 0.04 g of PMMA (stabilizing agent), having a MW of 15 kg/mole, were dissolved into 3.0 ml dichloromethane (forming an oil phase for an emulsion), whilst 0.06 g of polyvinylalcohol (carrier material), having a MW of 8-9 kg/mole (80% hydrolysed), and 0.30 g of PVP K25 (sourced from Fluka) were dissolved into 9 ml of deionised water (forming an aqueous phase for an emulsion). The oil phase (internal phase) was added into the aqueous phase (continuous phase) and the mixture was sonicated at level 5 for 55 seconds in an ice bath. The resultant emulsion was then spray dried under the following spray-drying conditions:
Inlet Temperature: 110° C.
Atomization Pressure: 3 Bar
Aspiration: 100%
Pump rate: 15%

The resulting dried powder was dispersed into deionised water at a concentration of 3,000 ppm azoxystrobin and a translucent nano-dispersion was formed. The z-average nano-particle size of the azoxystrobin-PMMA nano-co-particles was 376 nm.

### Example 35—Comparative Example

0.20 g of azoxystrobin (strobilurin fungicide) was dissolved into 2.0 ml dichloromethane (forming an oil phase for an emulsion), whilst 0.30 g of polyvinylalcohol (carrier material), having a MW of 8-9 kg/mole (80% hydrolysed), was dissolved into 9 ml of deionised water (forming an aqueous phase for an emulsion). The oil phase (internal phase) was added into the aqueous phase (continuous phase) and the mixture was sonicated at level 5 for 55 seconds in an ice bath. The resultant emulsion was then spray dried under the following spray-drying conditions:
Inlet Temperature: 110° C.
Atomization Pressure: 3 Bar
Aspiration: 100%
Pump rate: 15%

The resulting dried powder was dispersed into deionised water at a concentration of 3,000 ppm azoxystrobin and a translucent nano-dispersion was formed. The z-average nano-particle size of the azoxystrobin nanoparticles was 315 nm.

### Example 36—Comparative Example

0.36 g of azoxystrobin (strobilurin fungicide) was dissolved into 2.0 ml dichloromethane (forming an oil phase for an emulsion), whilst 0.06 g of polyvinylalcohol (carrier material), having a MW of 8-9 kg/mole (80% hydrolysed), and 0.30 g of PVP K25 (sourced from Fluka) were dissolved into 9 ml of deionised water (forming an aqueous phase for an emulsion). The oil phase (internal phase) was added into the aqueous phase (continuous phase) and the mixture was sonicated at level 5 for 55 seconds in an ice bath. The resultant emulsion was then spray dried under the following spray-drying conditions:
Inlet Temperature: 110° C.
Atomization Pressure: 3 Bar
Aspiration: 100%
Pump rate: 15%

The resulting dried powder was dispersed into deionised water at a concentration of 3,000 ppm azoxystrobin and a translucent nano-dispersion was formed. The z-average nano-particle size of the azoxystrobin nanoparticles was 339 nm.

The stability of each of the nano-dispersions formed in Examples 29 to 34 was compared to the stability of the nano-dispersions formed in Comparative Examples 35 and 36. All eight nano-dispersions were frequently monitored for any change in the z-average particle size over a 24-hour period at ambient temperature and ambient pressure, the results of which are shown in Table V below.

TABLE V

| | Particle Size (Z-Average) (nm) | | | % Increase |
|---|---|---|---|---|
| | | After 4 | After 24 | in Particle |
| Example | Initially | hours | hours | Size |
| 29 | 278 | 286 | 337 | 21 |
| 30 | 288 | 281 | 320 | 11 |
| 31 | 291 | 283 | 320 | 10 |
| 32 | 282 | 289 | 345 | 22 |
| 33 | 314 | 373 | 755 | 140 |
| 34 | 376 | 423 | 402 | 7 |
| 35 | 315 | 422 | 3906 | 1140 |
| 36 | 339 | 392 | 4956 | 1362 |

As is clearly shown, the initial particle size of the azoxystrobin nano-co-particles and the azoxystrobin only particles is relatively similar when Examples 29 to 34 (with stabilizing agent added) are compared to Examples 35 and 36 (without any stabilizing agent). However, overall, the longer-term stability of the nano-dispersions in accordance with the invention is much improved compared to a prior art nano-dispersion, with which a massive >1000% increase in z-average particle size is observed in just a 24-hour window.

### Example 37

An organic solution (forming the oil phase of an emulsion) of dichloromethane (2 ml), azoxystrobin (0.2 g—strobilurin fungicide) and PMMA (0.035 g—stabilizing agent), having an MW of 15 kg/mole, was added to an aqueous solution of deionised water (9 ml) and PVA (80% hydrolysed) (0.256 g—carrier material) (forming the aqueous phase of an emulsion). The two-phase solution was sonicated at level 5 for 55 seconds in an ice bath. The resultant emulsion was then spray dried under the following spray-drying conditions:
Inlet Temperature: 110° C.
Atomization Pressure: 3 Bar
Aspiration: 100%
Pump rate: 15%

The resulting dried powder was dispersed into deionised water at a concentration of 10 mg/ml in deionised water using a vortex mixer until a translucent nano-dispersion was formed. The z-average nano-particle size of the azoxystrobin-PMMA nano-co-particles was 199 nm.

### Example 38

An organic solution (forming the oil phase of an emulsion) of dichloromethane (3 ml), azoxystrobin (0.250 g—strobilurin fungicide) and PMMA (0.063 g—stabilizing agent), having an MW of 15 kg/mole, was added to an aqueous solution of deionised water (9 ml) and PVA (80% hydrolysed) (0.188 g—carrier material) (forming the aqueous phase of an emulsion). The two-phase solution was sonicated at level 5 for 55 seconds in an ice bath. The resultant emulsion was then spray dried under the following spray-drying conditions:
Inlet Temperature: 110° C.
Atomization Pressure: 3 Bar
Aspiration: 100%
Pump rate: 15%

The resulting dried powder was dispersed into deionised water at a concentration of 10 mg/ml in deionised water using a vortex mixer until a translucent nano-dispersion was formed. The z-average nano-particle size of the azoxystrobin-PMMA nano-co-particles was 191 nm.

### Example 39

An organic solution (forming the oil phase of an emulsion) of dichloromethane (3 ml), azoxystrobin (0.250 g—strobilurin fungicide), PMMA (0.056 g z—stabilizing agent), having an MW of 15 kg/mole, and cetyl alcohol (0.028 g) was added to an aqueous solution of deionised water (9 ml) and PVA (80% hydrolysed) (0.167 g—carrier material) (forming the aqueous phase of an emulsion). The two-phase solution was sonicated at level 5 for 55 seconds in an ice bath. The resultant emulsion was then spray dried under the following spray-drying conditions:
Inlet Temperature: 110° C.
Atomization Pressure: 3 Bar
Aspiration: 100%
Pump rate: 15%

The resulting dried powder was dispersed into deionised water at a concentration of 10 mg/ml in deionised water using a vortex mixer until a translucent nano-dispersion was formed. The z-average nano-particle size of the azoxystrobin-PMMA nano-co-particles was 185 nm.

### Example 40

1.30 g of azoxystrobin (strobilurin fungicide), 0.3 g of PMMA (stabilizing agent), having a MW of 15 kg/mole, and 0.15 g of cetaryl alcohol were dissolved into 9.0 ml dichloromethane and 3.0 ml of isopropyl alcohol (forming an oil phase for an emulsion). 0.90 g of polyvinylalcohol (carrier material), having a MW of 8-9 kg/mole (80% hydrolysed), was dissolved into 27 ml of deionised water (forming an aqueous phase for an emulsion). The oil phase (internal phase) was added into the aqueous phase (continuous phase) and the mixture was sonicated using a Hielscher UP400S sonicator fitted with an H7 probe at 100% for 65 seconds in an ice bath. The resultant emulsion was then spray dried under the following spray-drying conditions:
Inlet Temperature: 140° C.
Atomization Pressure: 3 Bar
Aspiration: 100%

The resulting dried powder was dispersed into deionised water and a translucent nano-dispersion was formed. The z-average nano-particle size of the azoxystrobin-PMMA nano-co-particles was 197 nm.

### Example 41

An organic solution (forming the oil phase of an emulsion) of dichloromethane (3 ml), azoxystrobin (0.250 g—strobilurin fungicide) and PMMA (0.056 g—stabilizing agent), having an MW of 15 kg/mole, was added to an aqueous solution of deionised water (9 ml), PVA (80% hydrolysed) (0.167 g) and HPC 80 (0.028 g) (both carrier materials, which form the aqueous phase of an emulsion). The two-phase solution was sonicated at level 5 for 55 seconds in an ice bath. The resultant emulsion was then spray dried under the following spray-drying conditions:
Inlet Temperature: 110° C.
Atomization Pressure: 3 Bar
Aspiration: 100%
Pump rate: 15%

The resulting dried powder was dispersed into deionised water forming a translucent nano-dispersion. The z-average nano-particle size of the azoxystrobin-PMMA nano-co-particles was 199 nm.

### Example 42

An organic solution (forming the oil phase of an emulsion) of dichloromethane (3 ml), azoxystrobin (0.250 g—strobilurin fungicide), PMMA (0.056 g stabilizing agent), having an MW of 15 kg/mole, and Span™ 60 (0.028 g—surfactant) was added to an aqueous solution of deionised water (9 ml) and PVA (80% hydrolysed) (0.167 g—carrier material) (forming the aqueous phase of an emulsion). The two-phase solution was sonicated at level 5 for 55 seconds in an ice bath. The resultant emulsion was then spray dried under the following spray-drying conditions:
Inlet Temperature: 110° C.
Atomization Pressure: 3 Bar
Aspiration: 100%
Pump rate: 15%

The resulting dried powder was dispersed into deionised water forming a translucent nano-dispersion. The z-average nano-particle size of the azoxystrobin-PMMA nano-co-particles was 193 nm.

The initial particle size of each of the nano-dispersions formed in Examples 37 to 42 was compared to the initial particle size of the nano-dispersions formed in Comparative Examples 35 and 36, the results of which are shown in Table VI below.

TABLE VI

| Example | Particle Size (Z-Average) (nm) |
|---|---|
| 35 | 315 |
| 36 | 339 |
| 37 | 199 |
| 38 | 191 |
| 39 | 185 |
| 40 | 197 |
| 41 | 199 |
| 42 | 193 |

As is clearly shown, the initial particle size of the azoxystrobin nano-co-particles (Examples 37 to 42) is, in all cases, much smaller than the initial particle size of the azoxystrobin only particles (Comparative Examples 35 and 36).

### Efficacy Test Results

### First Test

The first efficacy test performed was an in-vitro assessment of nano-co-particle formulations of the strobilurin fungicide azoxystrobin on amended Potato Dextrose Agar (PDA). In particular, the test was used to assess the activity of nano-suspension formulations of azoxystrobin against the fungal pathogen Fusarium culmorum.

Stock formulations of twelve azoxystrobin nano-suspensions (in accordance with Examples 29-34 and 37-42 of the invention) and a conventional stock formulation of commercially available azoxystrobin (Amistar™—Reference)) were each made up aseptically in sterile distilled water to give a concentration of 200 ppm active ingredient (Al). Appropriate volumes of each of the stock formulations were added to molten PDA (at 50° C.) to give a concentration of azoxystrobin of 4 ppm, with untreated PDA as a control. Each sample was also treated with penicillin and streptomycin to prevent inadvertent bacterial contamination. Aliquots (3 mL) of each sample were pipetted into square Petri dishes (plates) with a 5×5 matrix of wells. The overall dimension of the plates was 100 mm square, with each cell having an in internal length of 19.5 mm.

After loading the plates with agar, they were inoculated in the centre of each cell with a 2 μL droplet of a spore suspension of F. culmorum (10⁶ spores mL⁻¹). The plates were then incubated in a controlled-environment room with a constant temperature of 20° C.

Growth of the F. culmorum colonies was assessed using digital callipers at intervals after inoculation. The results obtained after three days are shown in Table VII below.

TABLE VII

| Example | Mean Colony Diameter (mm) |
|---|---|
| Reference Sample | 9.1 |
| (Amistar ™) | |
| 29 | 9.225 |
| 30 | 7.175 |
| 31 | 9.175 |
| 32 | 8.925 |
| 33 | 9.325 |
| 34 | 7.775 |
| 37 | 7.675 |
| 38 | 9.125 |
| 39 | 9.375 |
| 40 | 7.825 |
| 41 | 9.375 |
| 42 | 8.850 |

The lower the value of the mean colony diameter, the more efficacious a particular formulation is against fungal colony growth. As can be seen, Examples 30, 32, 34, 37, 40 and 42 are all more efficacious than the reference sample, with Examples 30, 34, 37 and 40 (highlighted in bold text in Table VII) showing a marked improvement in reducing the amount of growth of a fungal colony of F. culmorum. FIG. 2 depicts these results graphically.

### Second Test

The second efficacy test performed was an in planta assessment of nano-co-particle formulations of the strobilurin fungicide azoxystrobin on the wheat pathogen, brown rust (Puccinia recondite) under glasshouse conditions. Brown rust is an obligate biotroph (meaning that it cannot be cultured) and thus cannot be grown in a laboratory on demand; Inoculum (i.e. an inoculum of the wheat pathogen, brown rust) was therefore raised on source plants of susceptible wheat varieties. The wheat variety “Solstice” was used in this test.

Four nano-suspension formulations (from Examples 30, 34, 37 and 40) were compared with a reference formulation made with commercially available Amistar™ (Reference). Wheat plants were treated with the reference formulation at equivalent field rates* of (a) 1.0 L ha⁻¹ (full field rate) and at lower equivalent rates of (b) 0.5 and (c) 0.25 L ha⁻¹, to emphasise any differences in disease control efficacy. The nano-suspension formulations were applied to give the same doses of active ingredient as Amistar™ (Reference) at these three equivalent dosages. An equivalent field rate is calculated on the basis that the full field rate is equivalent to 1 L of Amistar™ made up in 200 L tap water and that 1 L of Amistar™ contains 250 g of azoxystrobin.

Using a hand-held calibrated pressurised spray gun, curative treatments were made to the plants at growth stage 12, four days after their inoculation with the pathogens. At the curative stage, the fungi were internalised but the plants did not exhibit disease symptoms. The brown rust pathogen was applied as dry spores and the treated plants were subsequently bagged for 24 hours at 100% RH to facilitate infection. Inoculated plants were maintained in a research glasshouse. Three replicate pots, with 10 plants per pot, were inoculated for each of the reference sample and the four inventive Examples. Efficacy was evaluated by disease assessment 14 days after inoculation Thirty randomly-selected leaves were scored for each treatment, using a standard visual key to assist evaluation. The mean disease score results are shown in Table VIII below.

SCORING SYSTEM

| % of leaf area showing | |
|---|---|
| visible rust | Mean Disease Score |
| 0 | 0 |
| 1 (trace) | 1 |
| 2-4 | 3 |
| 5-9 | 7 |
| 10-20 | 15 |
| 21-40 | 30 |
| 41-60 | 50 |

TABLE VIII

| | Treatment Regime | | |
|---|---|---|---|
| Example | (a) 1 L/ha | (b) 0.5 L/ha | (c) 0.25 L/ha |
| Reference | 8.80 | 10.20 | 16.43 |
| 30 | 8.87 | 11.17 | 13.27 |
| 34 | 3.67 | 4.43 | 6.90 |
| 37 | 9.00 | 10.37 | 14.77 |
| 40 | 3.23 | 4.30 | 10.67 |

| | |
|---|---|
| Untreated Wheat | 24.67 |
| Plant | |

The lower the value of mean disease score, the more efficacious a particular formulation is at curing wheat brown rust. As can be seen, all of the Examples show a much reduced disease score as compared to the untreated wheat plant. However comparing each of Examples 30, 34, 37 and 40 with the Reference, it is clear that the Example 34 and 40 formulations both perform better than the Reference sample across all three treatment regimes (a), (b) and (c). Furthermore, the Example 30 and 37 formulations performs better than the Reference at the equivalent rate of (c) 0.25 L/ha. FIG. 3 depicts these results graphically.

### Third Test

The third efficacy test performed was another in-planta assessment of the same Example formulations as were used in the second test against wheat brown rust, only this time for the preventative efficacy (rather than the curative efficacy measured in the second test). Thus the same methodology of the second test was followed, however the preventative fungicide applications were made to plants at growth stage 12, one hour before inoculation with the pathogens. The mean disease score results are shown in Table IX below.

TABLE IX

| | Treatment Regime | | |
|---|---|---|---|
| Example | (a) 1 L/ha | (b) 0.5 L/ha | (c) 0.25 L/ha |
| Reference | 7.60 | 10.57 | 14.80 |
| 30 | 7.33 | 11.40 | 14.17 |
| 34 | 2.80 | 3.50 | 5.60 |
| 37 | 7.03 | 9.13 | 13.80 |
| 40 | 3.47 | 5.53 | 7.17 |

| | |
|---|---|
| Untreated Wheat | 26.43 |
| Plant | |

The lower the value of mean disease score, the more efficacious a particular formulation is at preventing wheat brown rust. As can be seen, all of the Examples show a much reduced disease score as compared to the untreated wheat plant. However comparing each of Examples 30, 34, 37 and 40 with the Reference, it is clear that all of the Example formulations (with the exception of Example 30 at (b) 0.5 L/ha equivalent rate) perform better than the Reference sample across all three treatment regimes. FIG. 4 depicts these results graphically.

### Fourth Test

Finally a fourth test was performed which was a field trial that was undertaken using plots of an existing crop of wheat, variety “Duxford”. This particular variety is susceptible to brown rust (Puccinia triticina), which commonly causes late-season infection of flag leaves. The nano-suspension formulation of Example 40 (which has been shown in the first, second and third tests to be a particularly efficacious formulation) was applied to the plants at growth stage 65, which is within the window for a T3 fungicide application.

The Reference (as above) and the formulation of Example 40 were applied with a hand-held pressurised sprayer at rates equivalent to (a) 1.0, (b) 0.5 and (c) 0.25 L ha⁻¹ Amistar™, in 200 L water ha⁻¹. Control samples were left untreated for comparison. The treatments were arranged in randomised plots in four replicate blocks. Each plot was 1×2 m.

Post-application of the formulations, disease assessments were made at weekly intervals by randomly selecting 10 flag leaves from each plot and assessing brown rust infection using the key described below. Thus 40 leaf assessments were made for each treatment at each time. Plots were assessed ‘blind’ to preclude inadvertent bias in scoring.

SCORING SYSTEM

| % of leaf area showing | |
|---|---|
| visible rust | Mean Disease Score |
| 0 | 0 |
| 1 (trace) | 1 |
| 2-4 | 3 |
| 5-9 | 7 |
| 10-20 | 15 |

The mean disease score results are shown in Table X below.

TABLE X

| | Treatment Regime | | |
|---|---|---|---|
| Example | (a) 1 L/ha | (b) 0.5 L/ha | (c) 0.25 L/ha |
| Reference | 1.85 | 3.48 | 4.28 |
| 40 | 1.28 | 2.33 | 2.83 |

| | |
|---|---|
| Untreated Wheat | 5.55 |
| Plant | |

The lower the value of mean disease score, the more efficacious a particular formulation is at preventing wheat brown rust. As can be seen, all of the Examples show a much reduced disease score as compared to the untreated wheat plants. However comparing Example 40 with the Reference, it is clear that Example formulation 40 performs better than the Reference sample across all three treatment regimes (a), (b) and (c). FIG. 5 depicts these results graphically.

The following further Examples have also been completed with a different active agent, namely kresoxim-methyl, in an amount of 10% by weight so as to achieve 0.14% active in the emulsion formed, according to the following processing conditions:

Kresoxim-methyl and an amount of stabilizing agent were dissolved into a volume of dichloromethane (forming an oil phase for an emulsion), whilst an amount of carrier material was dissolved into a volume of deionised water (forming an aqueous phase for an emulsion), as described in Table XI below. The oil phase (internal phase) was added into the aqueous phase (continuous phase) and the mixture was sonicated at 20% power for 30 seconds. The resultant emulsion, having a total solids content of 100 mg, was then spray dried under the following spray-drying conditions:
Inlet Temperature: 110° C.
Outlet Temperature: 68-83° C.
Aspiration: 100%
Pump Rate: 10%

The resulting dried powder was dispersed into deionised water at a concentration of 1 mg/ml with 1-2 minutes of vortex mixing, and a translucent nano-dispersion was formed. The z-average size (measured 15 minutes post-dispersion) of the particles formed are also described in Table XI, along with relevant comparative examples (denoted with an asterisk), whilst time-dependent z-average particle sizes for a number of these examples are down in Table XII.

TABLE XI

| Ex. | A | B | C | D | E | F | G | |
|---|---|---|---|---|---|---|---|---|
| 43 | 85% | 5% PS | — | 6:1.125 | 287 | 1.40 | 15-20 | min |
| | PVA 4-88 | (35k) | | | | | | |
| 44* | 90% | — | — | 6:1 | 1300 | 1.43 | 10 | min |
| | PVA 4-88 | | | | | | | |
| 45 | 75% | 5% PS | 10% | 6:1.125 | 165 | 1.40 | 15 | min |
| | PVP k17 | (35k) | AOT | | | | | |
| 46* | 80% | — | 10% | 6:1 | 263 | 1.43 | 15 | min |
| | PVP k17 | | AOT | | | | | |
| 47 | 75% | 5% PS | 10% | 6:1.125 | 225 | 1.40 | 15 | min |
| | PVA 4-88 | (35k) | AOT | | | | | |
| 48 | 75% | 5% | 10% | 6:1.125 | 234 | 1.40 | 10 | min |
| | PVA 4-88 | PMMA | AOT | | | | | |
| | | (15k) | | | | | | |
| 49* | 80% | — | 10% | 6:1 | 480 | 1.43 | 10 | min |
| | PVA 4-88 | | AOT | | | | | |
| 50 | 75% | 5% PS | 10% | 6:1.125 | 213 | 1.40 | 10 | min |
| | PVP k17 | (35k) | SDS | | | | | |
| 51 | 75% | 5% | 10% | 6:1.125 | 195 | 1.40 | 10 | min |
| | PVP k17 | PMMA | SDS | | | | | |
| | | (15k) | | | | | | |
| 52* | 80% | — | 10% | 6:1 | — | 1.43 | Immediate | |
| | PVP k17 | | SDS | | | | Precipitate | |
| 53 | 75% | 5% PS | 10% | 6:1.125 | 230 | 1.40 | 15 | min |
| | PVA 4-88 | (35k) | SDS | | | | | |
| 54 | 75% | 5% | 10% | 6:1.125 | 233 | 1.40 | 15 | min |
| | PVA 4-88 | PMMA | SDS | | | | | |
| | | (15k) | | | | | | |
| 55* | 80% | — | 10% | 6:1 | 310 | 1.43 | 10 | min |
| | PVA 4-88 | | SDS | | | | | |

wherein:
A = percentage by weight of hydrophilic polymer in the emulsion
B = percentage by weight of hydrophobic polymer in the emulsion
C = amount of surfactant in the emulsion
D = ratio of dichloromethane (ml) to deionised water (ml)
E = z-average particle size of the resultant particles (measured after 15 minutes post-dispersion of the particles)
F = percentage of material (other than solvent) in the emulsion
G = stability of the emulsion prior to spray-drying.

TABLE XII

| | Particle Size (z-average) (nm) | | | | |
|---|---|---|---|---|---|
| Ex. | 3 mins | 7 mins | 11 mins | 15 mins | 19 mins |
| 43 | 295 | 289 | 288 | 287 | 285 |
| 44* | 339 | 288 | — | 1300 | 2100 |
| 47 | 242 | 228 | 227 | 225 | 219 |
| 48 | 255 | 243 | 236 | 234 | 229 |
| 49* | 335 | 401 | 564 | 480 | 494 |
| 50 | 221 | 216 | 216 | 213 | 211 |
| 51 | 212 | 204 | 196 | 195 | 197 |
| 52* | 1500 | 2300 | 2700 | — | — |

As is clearly shown in Table XI, the initial particle size of the nano-co-particles of the invention (of Examples 43, 45, 47, 48, 50, 51, 53 and 54) is much smaller than the corresponding particle size of the un-stabilized particles (of Examples 46, 49, 52 and 55) formed without use of a hydrophobic polymer.

Furthermore, as is clearly shown in Table XII, the longer-term stability of the nano-dispersions in accordance with the invention is much improved compared to a prior art nano-dispersion, with the size of particles formed according to the invention being at least constant if not reducing, whilst the size of prior art particles formed increase over time. For comparative examples 44 and 52 in particular, the increase shown is massive from an already larger initial particle size.

1. A method for preparing an improved composition comprising at least one water-insoluble active agent and at least one solid water-soluble carrier material, wherein the active agent is dispersed through the carrier material in nano-disperse form, which method comprises the steps of:
(a) forming an oil-in-water emulsion comprising:
(i) a solution of the active agent and a water-insoluble stabilizing agent in a first solvent, wherein the first solvent is a water-immiscible non-aqueous solvent, and
(ii) a solution of the carrier material in a second solvent, wherein the second solvent is water, and
(b) drying the emulsion to remove the first and second solvents to obtain a substantially solvent-free nano-dispersion of the active agent stabilized by the stabilizing agent in the carrier material,
wherein the stabilizing agent is capable of stabilizing the active agent in the emulsion during drying and in a resultant liquid nano-dispersion of the improved composition.

2-7. (canceled)

8. A method according to claim 1 wherein the stabilizing agent is hydrophobic.

9. A method according to claim 8 wherein the hydrophobic stabilizing agent is a polymeric material.

10. A method according to claim 9 wherein the polymeric material has a weight average molecular weight (MW) in the range of from 10-500 kg/mole.

11. A method according to claim 10 wherein the polymeric material is selected from polymethylmethacrylate (PMMA), polymethylmethacrylate-co-methacrylic acid (PMMA-MA), polybutylmethacrylate (PBMA), polystyrene (PS), polyvinylacetate (PVAC), polypropyleneglycol (PPG) poly(styrene-co-methyl methacrylate), poly(vinylpyrrolidone-co-vinyl acetate), poly(vinyl acetate-co-croton-aldehyde, and mixtures thereof.

12. A method according to claim 1 wherein the active agent is selected from a pharmaceutical, a nutraceutical, an animal health product, an agrochemical, a biocidal compound, a food additive (including flavourings), a polymer, a protein, a peptide, a cosmetic ingredient, a coating, an ink/dye/colourant, a laundry or household cleaning and care product, and mixtures thereof.

13. A method according to claim 1 wherein the carrier material is selected from one or more inorganic materials, surfactants, polymers, sugars and mixtures thereof.

14. A method according to claim 13 wherein the carrier material is a polymer selected from polyvinylalcohol (PVA), polyethylene glycol (PEG), polyvinylpyrrolidone (PVP), poly(2-ethyl-2-oxazaline), hydroxypropylcellulose (HPC) and hydroxypropylmethylcellulose (HPMC) and alginate, and mixtures thereof.

15. A method according to claim 13 wherein the carrier material is a surfactant selected from alkoxylated non-ionic surfactant, ether sulfate surfactant, cationic surfactant and ester surfactant, and mixtures thereof.

16. (canceled)

17. A method according to claim 1 wherein the non-aqueous solvent is selected from toluene, cyclohexane, dichloromethane, trichloromethane (chloroform), ethyl acetate, 2-butanone, and mixtures thereof.

18. A method according to claim 1 wherein the drying step is a spray-drying process.

19. A method according to claim 1 wherein the drying step is a freeze-drying process.

20. A method according to claim 1 wherein the drying step is a spray-granulation process.

21. An improved composition in the form of a nano-dispersion of an active agent with a stabilizing agent in a carrier material obtained by the method of claim 1.

22. An improved liquid nano-dispersion of an active agent with a stabilizing agent and a carrier material obtained by combining a liquid with the improved composition of claim 21.

23-25. (canceled)
